(19) United States
(12) Patent Application Publication
(10) Pub. No.: US 2011/0026126 A1
(43) Pub. Date: Feb. 3, 2011

(54) Antireflection film, polarizing plate and image display device

(75) Inventors: Katsuyuki Takada, Kanagawa (JP); Hiroyuki Yoneyama, Kanagawa (JP); Masaaki Suzuki, Kanagawa (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/805,444

(22) Filed: Jul. 30, 2010

(30) Foreign Application Priority Data
Jul. 31, 2009 (JP) 2009-180220

(51) Int. Cl. G02B 1/11; B32B 27/28; B32B 27/20

(52) U.S. Cl. 359/601; 428/421; 428/419; 428/323; 428/313.3; 428/313.9

(57) ABSTRACT

An antireflection film includes a support and a low refractive index layer formed from a composition for low refractive index layer containing (A) a polyfunctional fluorine-containing monomer having a polymerizable group and (B) a hydrophobilized conductive polymer composition containing a π-conjugated system conductive polymer and an anion group-containing polymer dopant, and a common logarithm log(SR) of a surface resistivity SR (Ω/sq) of a surface of the antireflection film on a side at which the low refractive index layer is provided is not more than 13.0.

### FIELD OF THE INVENTION

The present invention relates to an antireflection film, a polarizing plate and an image display device. In more detail, the invention relates to an antireflection film having high antistatic properties and antireflection properties, a polarizing plate using the subject antireflection film and an image display device using the subject antireflection film or the subject polarizing plate for the outermost surface of a display.

### BACKGROUND OF THE INVENTION

In general, in images display devices such as a cathode ray tube display device (CRT), a plasma display panel (PDP), an electroluminescent display (ELD) and a liquid crystal display device (LCD), for the purpose of preventing a lowering of contrast to be caused due to reflection of external light or reflection of an image, an antireflection film is disposed on the outermost surface of a display, thereby reducing a reflectance by utilizing a principle of optical interference.

In general, the antireflection film can be prepared by forming, on a support, a low refractive index layer having a refractive index lower than that of the support and having an appropriate film thickness directly or via other layer. In order to realize a low reflectance, it is desirable to use a material having a low refractive index as far as possible for the low refractive index layer. Also, since the antireflection film is used for the outermost surface of the display, it is required to have high scar resistance. For example, in a thin film having a thickness of about 100 nm, in order to realize high scar resistance, strength of the film itself and adhesion to a lower layer are necessary.

In order to decrease the refractive index of the material, a method for introducing a fluorine atom is known, and in particular, a measure of using a fluorine atom-containing crosslinking material is proposed (see JP-A-2006-28409). However, in the case where a fluorine atom-containing layer is used for the outermost surface of an antireflection film, if a proportion of the fluorine atom in the compound is increased for the purpose of lowering the refractive index, the film surface is easy to become minus charged, and motes may be easy to attach.

From the viewpoint of reducing the mute attachment, there is known a method in which the antireflection film is provided with a conductive layer (antistatic layer), thereby leaking a charge on the surface of the antireflection film.

For example, in JP-A-2003-294904, JP-A-11-92750 and JP-A-2005-196122, a conductive particle composed of a metal oxide is contained in the layer. According to this method, it is necessary to newly provide a layer other than the low refractive index layer, and there is involved such a problem that loads of equipment and time are large so that the productivity is inferior. Also, since the majority of conductive particles composed of a metal oxide for the purpose of preventing the electrification, which are in general conventionally used, have a refractive index of from about 1.6 to 2.2, the refractive index of an antistatic layer containing such a particle increases. When the refractive index of the antistatic layer is high, in an optical film, there is caused such a problem that non-intended interference unevenness is caused due to a difference in a refractive index from an adjacent layer, or a color tint of the reflected color becomes strong.

JP-A-2007-185824, JP-A-2005-316425 and JP-A-2007-293325 disclose an embodiment in which ion-conducting or electron-conducting conductive material is added in a low refractive index layer.

However, the materials specifically disclosed in the working examples of JP-A-2007-185824, JP-A-2005-316425 and JP-A-2007-293325 are an ion-conducting material, and there was the case where the conductivity is not always sufficient depending upon the environmental moisture. Also, JP-A-2007-185824, JP-A-2005-316425 and JP-A-2007-293325 disclose organic conductive polymer compounds such as polyaniline and polythiophene, both of which are a conductive polymer, as illustrative compounds. However, in the case where such a compound is merely introduced into a low refractive index layer as it is, it does not substantially have conductivity and is required to be partially oxidized by doping.

However, a conductive polymer containing an anion dopant which is generally used is high in hydrophilicity and low in affinity with a material such as a polyfunctional fluorine-containing monomer, and it was difficult to form a low refractive index layer with excellent surface properties using such a material. European Patent No. 328,981 discloses that an organic solvent-soluble thiophene derivative can be synthesized by electrolytic polymerization in an organic solvent system using a thiophene derivative and an organic solvent-soluble monomer dopant. However, though there is a tendency that this organic solvent-soluble polythiophene derivative is improved with respect to the affinity with a polyfunctional fluorine-containing monomer, it has become clear that when used for an antireflection film for a protective film of a polarizing plate, the monomer dopant elutes by an alkali treatment (saponification treatment), resulting in causing a problem that the conductivity is remarkably lowered.

### SUMMARY OF THE INVENTION

An object of the invention is to provide an antireflection film which has excellent antireflection properties, antistatic properties, scar resistance, adhesion and antifouling properties and which is excellent in productivity.

Also, another object of the invention is to provide an antireflection film which does not reply upon the circumstances where the antireflection film is dealt and which is excellent in antistatic properties. Also, a further object of the invention is to provide an antireflection film whose antistatic ability is not lowered by a saponification treatment at the time of preparation of a polarizing plate.

A still another object of the invention is to provide a polarizing plate or an image display device using the foregoing antireflection film.

The present inventors made extensive and intensive investigations. As a result, it has been noted that the foregoing problems can be solved by using a composition using a specified conductive polymer composition jointly with a polyfunctional fluorine-containing monomer having a polymerizable group. Furthermore, in the configuration of the invention, it has become clear that there is brought such an unexpected effect that for the purpose of realizing scratch resistance and a low refractive index, even when an addition amount of the conductive polymer composition is reduced in a low refractive index layer, the conductivity is not remarkably lowered.

That is, the present inventors have obtained knowledge that by taking the following configurations, the foregoing problems can be solved, and the foregoing objects can be attained, leading to accomplishment of the invention.

1. An antireflection film comprising a support and a low refractive index layer formed from a composition for low refractive index layer containing the following (A) and (B), wherein a common logarithm log(SR) of a surface resistivity SR (Ω/sq) of the surface on the side on which the low refractive index layer is provided relative to the support (the surface of the antireflection film at the side in which the low refractive index layer is provided) is not more than 13.0:

(A) a polyfunctional fluorine-containing monomer having a polymerizable group; and

(B) a hydrophobilized conductive polymer composition containing a π-conjugated system conductive polymer and an anion group-containing polymer dopant.

2. The antireflection film as set forth above in 1, wherein the polymerizable group of the polyfunctional fluorine-containing monomer (A) having a polymerizable group is a polymerizable unsaturated group.
3. The antireflection film as set forth above in 1, wherein the polymerizable group of the polyfunctional fluorine-containing monomer (A) having a polymerizable group is any one group selected among an acryloyl group, a methacryloyl group and —C(O)OCH═CH₂.
4. The antireflection film as set forth above in any one of 1 to 3, wherein the π-conjugated system conductive polymer is any one member selected among polythiophene, polyaniline, a polythiophene derivative and a polyaniline derivative.
5. The antireflection film as set forth above in any one of 1 to 4, wherein the composition for low refractive index layer further contains at least one member selected from a fluorine-containing antifouling agent and a silicone based antifouling agent.
6. The antireflection film as set forth above in any one of 1 to 5, wherein the composition for low refractive index layer further contains an inorganic fine particle having a particle size of 5 nm or more and not more than 120 nm.
7. The antireflection film as set forth above in 6, wherein the inorganic fine particle is a fine particle having pores in the inside thereof.
8. The antireflection film as set forth above in any one of 1 to 7, wherein the π-conjugated system conductive polymer is maldistributed (unevenly distributed) in a film thickness direction of the low refractive index layer.
9. A polarizing plate comprising a polarizing film and a protective film for protecting at least one surface of the polarizing film, wherein the protective film is the antireflection film as set forth above in any one of 1 to 8.
10. An image display device comprising the antireflection film as set forth above in any one of 1 to 8 or the polarizing plate as set forth above in 9.

According to the invention, it is possible to provide an antireflection film which has excellent antireflection properties, antistatic properties, scar resistance, adhesion and antifouling properties and which is excellent in productivity.

Also, it is possible to provide an antireflection film which does not reply upon the circumstances where the antireflection film is dealt and which is excellent in antistatic properties and whose antistatic ability is not lowered by a saponification treatment at the time of polarizing plate preparation.

### DETAILED DESCRIPTION OF THE INVENTION

The invention is hereunder described in more detail. In this specification, in the case where a numerical value represents a physical property value, a characteristic value, etc., the terms “from (numerical value 1) to (numerical value 2)” mean “(numerical value 1) or more and not more than (numerical value 2)”. Also, in this specification, the term “(meth)acrylate” means “at least one of acrylate and methacrylate”. The same is also applicable to the terms “(meth)acrylic acid” or the like.

The antireflection film of the invention comprises a support and a low refractive index layer formed from a composition for low refractive index layer containing the following (A) and (B), wherein a common logarithm log(SR) of a surface resistivity SR (Ω/sq) of the surface on the side on which the low refractive index layer is provided relative to the support is not more than 13.0:

(A) a polyfunctional fluorine-containing monomer having a polymerizable group; and

(B) a hydrophobilized conductive polymer composition containing a π-conjugated system conductive polymer and an anion group-containing polymer dopant.

### ((A) Polyfunctional Fluorine-Containing Monomer Having a Polymerizable Group)

In the invention, it is essential that the composition for low refractive index layer contains (A) a polyfunctional fluorine-containing monomer having a polymerizable group (hereinafter also referred to as “polyfunctional fluorine-containing monomer”). The polyfunctional fluorine-containing monomer which is used in the invention has an atomic group composed mainly of plural fluorine atoms and carbon atoms (provided that at least one of an oxygen atom and a hydrogen atom may be contained in a part thereof) (the atomic group will be also referred to as “fluorine-containing core part”) and a polymerizable group.

It is preferable that the fluorine-containing core part and the polymerizable group are connected to each other via a connecting group containing an ester bond, an ether bond, etc.

The polymerizable group is preferably a polymerizable group such as a radical polymerizable group, an ionic polymerizable group and a condensation polymerizable group. Also, the polymerizable group is preferably a polymerizable unsaturated group or a ring-opening polymerizable group, with a polymerizable unsaturated group being more preferable. Specifically, a polymerizable group selected among a (meth)acryloyl group, an allyl group, an alkoxysilyl group, an α-fluoroacryloyl group, an epoxy group and —C(O)OCH═CH₂ is more preferable. Of these, from the viewpoint of polymerizability, a (meth)acryloyl group, an allyl group, an α-fluoroacryloyl group, an epoxy group and —C(O)OCH═CH₂ each having radical polymerizability or cationic polymerizability are preferable; a (meth)acryloyl group, an allyl group, an α-fluoroacryloyl group and —C(O)OCH═CH₂ each having radical polymerizability are especially preferable; and a (meth)acryloyl group and —C(O)OCH═CH₂ are the most preferable.

Also, it is preferable that the polyfunctional fluorine-containing monomer according to the invention has two or more polymerizable groups.

The polyfunctional fluorine-containing monomer in the invention is preferable one represented by the following general formula (I).

Rf{−(L)ₘ−Y}ₙ General Formula (I)

In the foregoing general formula (I), Rf represents a chain or cyclic n-valent group containing at least a carbon atom and a fluorine atom and optionally containing any one of an oxygen atom and a hydrogen atom; n represents an integer of 2 or more; L represents a single bond or a divalent connecting group; m represents 0 or 1; and Y represents a polymerizable group.

The polyfunctional fluorine-containing monomer may be a crosslinking agent having a crosslinking group as the polymerizable group. Examples of the crosslinking group include a silyl group having a hydroxyl group or a hydrolyzable group (for example, an alkoxysilyl group, an acyloxysilyl group, etc.), a group having a reactive unsaturated double bond (for example, a (meth)acryloyl group, an allyl group, a vinyloxy group, etc.), a ring-opening polymerization reactive group (for example, an epoxy group, an oxetanyl group, an oxazolyl group, etc.), a group having an active hydrogen group (for example, a hydroxyl group, a carboxyl group, an amino group, a carbamoyl group, a mercapto group, a β-keto ester group, a hydrosilyl group, a silanol group, etc.) and a group capable of being substituted with an acid anhydride or a nucleating agent (for example, an active halogen atom, a sulfonic acid ester group, etc.).

In the foregoing general formula (I), Y represents a polymerizable group. Y is preferably a radical polymerizable group, an ionic polymerizable group or a condensation polymerizable group; more preferably a polymerizable unsaturated group or a ring-opening polymerizable group; and further preferably a polymerizable unsaturated group. Specifically, a group selected among a (meth)acryloyl group, an allyl group, an alkoxysilyl group, an α-fluoroacryloyl group, an epoxy group and —C(O)OCH═CH₂ is more preferable. Of these, from the viewpoint of polymerizability, a (meth)acryloyl group, an allyl group, an α-fluoroacryloyl group, an epoxy group and —C(O)OCH═CH₂ each having radical polymerizability or cationic polymerizability are preferable; a (meth)acryloyl group, an allyl group, an α-fluoroacryloyl group and —C(O)OCH═CH₂ each having radical polymerizability are especially preferable; and a (meth)acryloyl group and —C(O)OCH═CH₂ are the most preferable.

L represents a single bond or a divalent connecting group and represents an alkylene group having from 1 to 10 carbon atoms, an arylene group having from 6 to 10 carbon group, —O—, —S—, —N(R)— or a divalent connecting group obtained by combining two or more kinds thereof, wherein R represents a hydrogen atom or an alkyl group having from 1 to 5 carbon atoms.

In the case where L represents an alkylene group or an arylene group, the alkylene group or arylene group represented by L is preferably substituted with a halogen atom, and more preferably substituted with a fluorine atom.

A preferred embodiment of the polymerizable fluorine-containing compound represented by the general formula (I) is one represented by the following general formula (I-1), (I-2), (I-3) or (I-4).

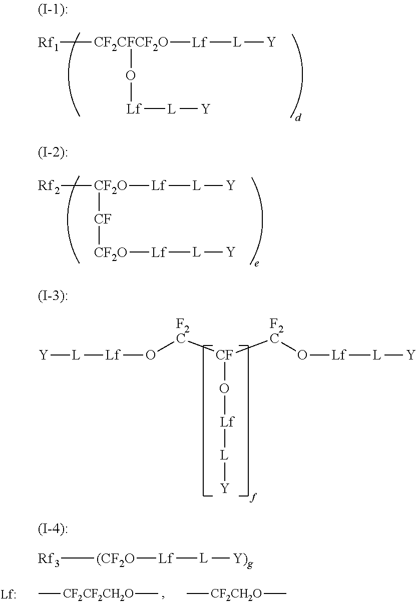

In the foregoing general formulae, Rf₁ represents a d-valent organic group which is a group constituted of only an oxygen atom, a carbon atom and a fluorine atom or a group constituted of only a carbon atom, a fluorine atom and an oxygen atom; Rf₂ represents an e-valent organic group which is a group constituted of only an oxygen atom, a carbon atom and a fluorine atom or a group constituted of only a carbon atom, a fluorine atom and an oxygen atom; Rf₃ represents a g-valent organic group which is a group constituted of only an oxygen atom, a carbon atom and a fluorine atom or a group constituted of only a carbon atom, a fluorine atom and an oxygen atom; Lf represents —CF₂CF₂CH₂O— or —CF₂CH₂O— (each of which is bonded to the oxygen atom on the carbon atom side); L and Y are synonymous with L and Y in the foregoing general formula (I); each of d, e and g independently represents an integer of 2 or more; and f represents an integer of 1 or ore more.

The carbon atom number of each of Rf₁ and Rf₂ is preferably from 0 to 30, and more preferably from 0 to 10.

A more preferred embodiment of the compound represented by the foregoing general formula (I-1), (I-2) or (1-3) is one represented by the following general formula (I-1′), (I-2′) or (I-3′).

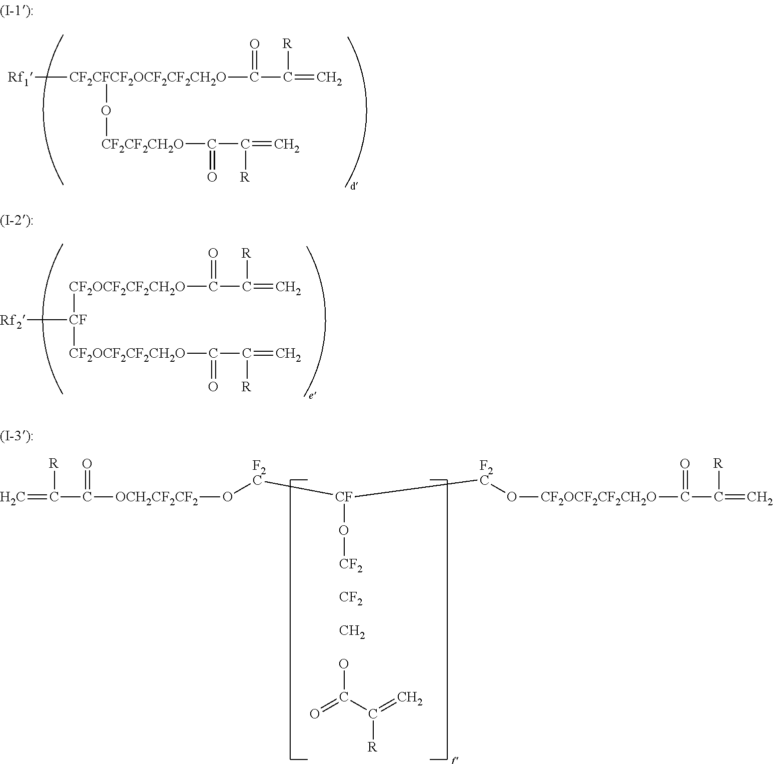

In the foregoing general formulae, Rf₁′ represents a d′-valent organic group which is a group constituted of only an oxygen atom, a carbon atom and a fluorine atom or a group constituted of only a carbon atom, a fluorine atom and an oxygen atom; Rf₂′ represents an e′-valent organic group which is a group constituted of only an oxygen atom, a carbon atom and a fluorine atom or a group constituted of only a carbon atom, a fluorine atom and an oxygen atom; R represents a hydrogen atom, a fluorine atom, an alkyl group (preferably an alkyl group having from 1 to 5 carbon atoms) or a fluoroalkyl group (preferably a perfluoroalkyl group having from 1 to 5 carbon atoms); each of d′ and e′ independently represents an integer of 2 or 3; and f′ represents an integer of from 1 to 4.

The carbon atom number of each of Rf₁′ and Rf₂′ is preferably from 0 to 30, and more preferably from 0 to 10.

Specific examples of the polyfunctional fluorine-containing monomer having a polymerizable group represented by the general formula (I) of the invention are given below, but it should not be construed that the invention is limited thereto.

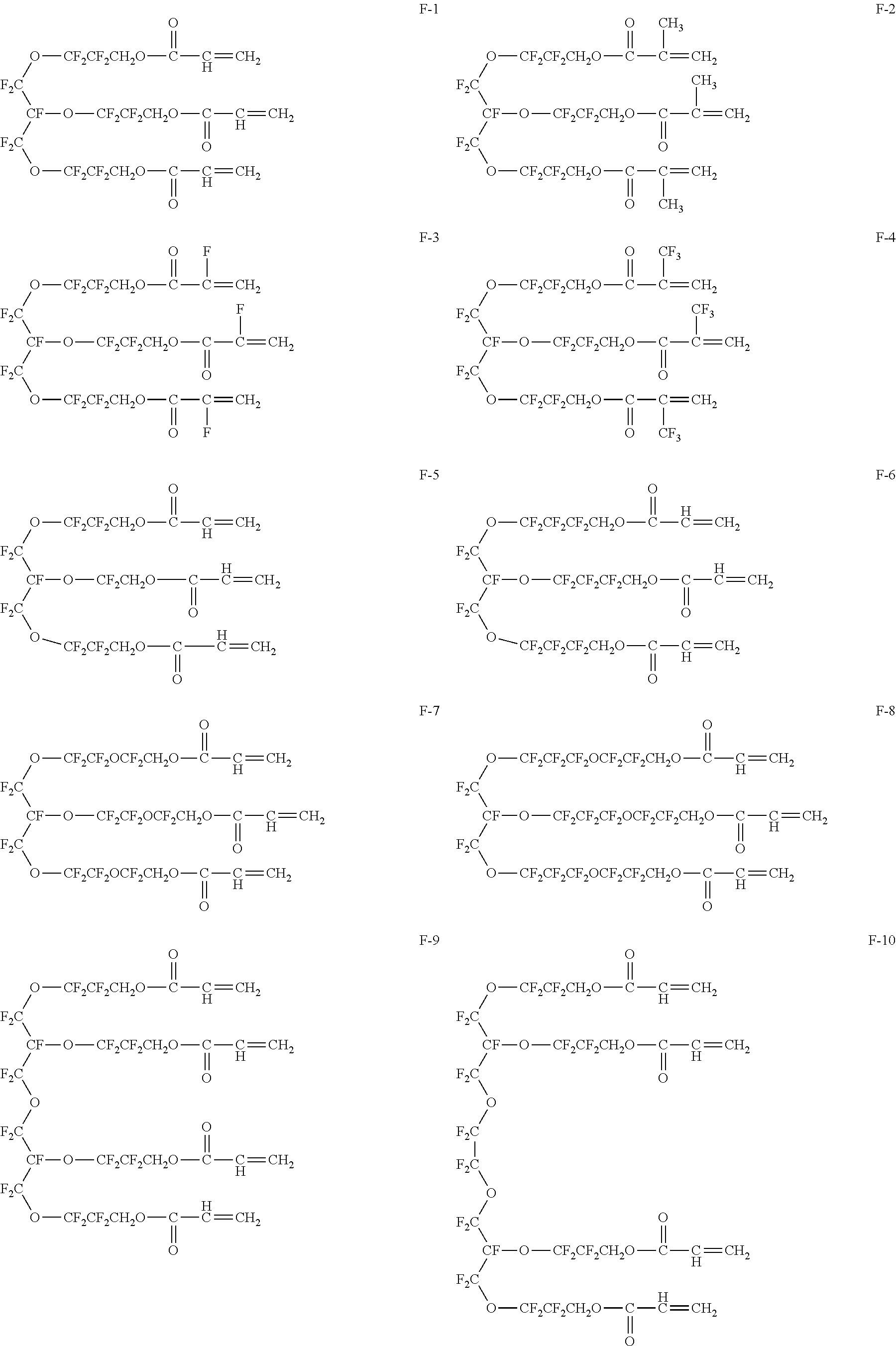

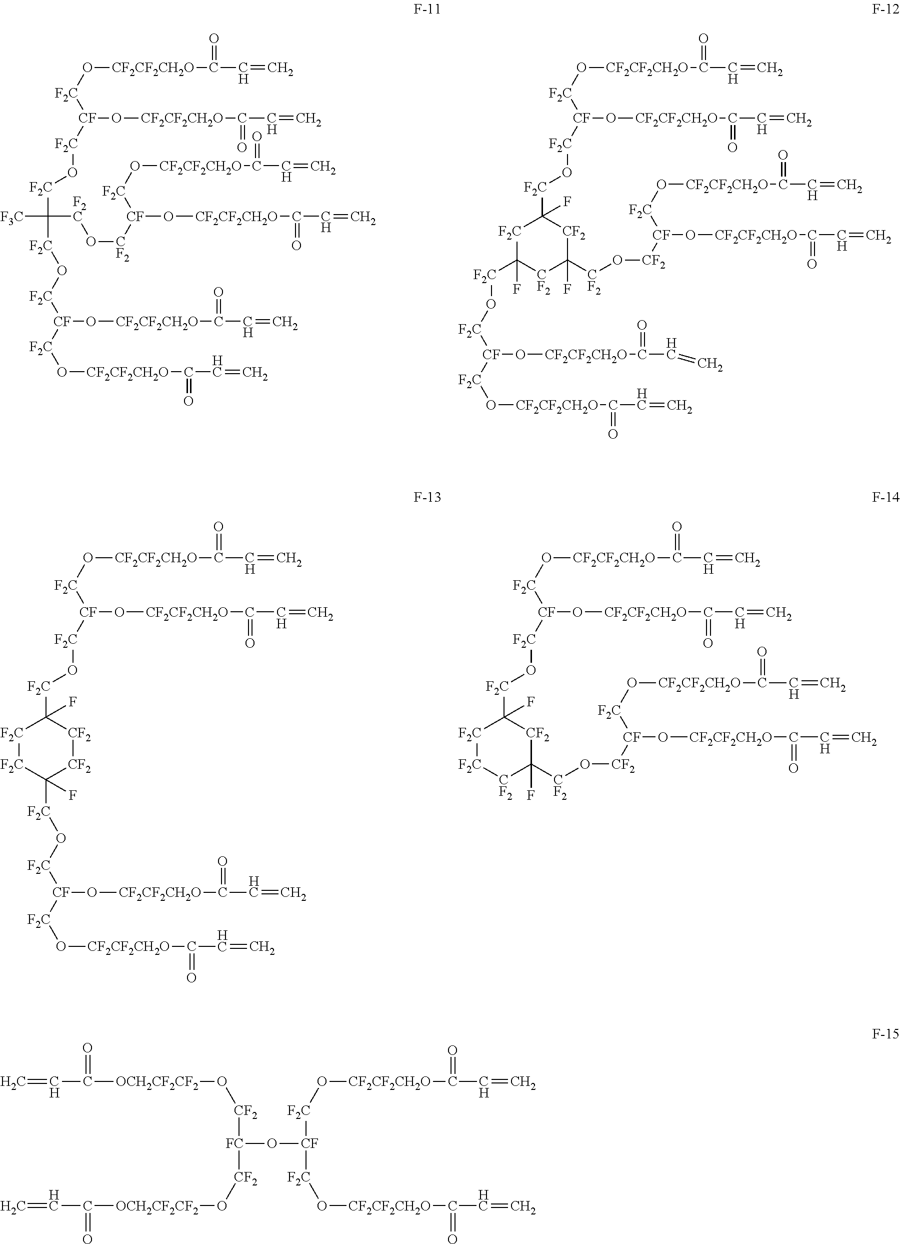

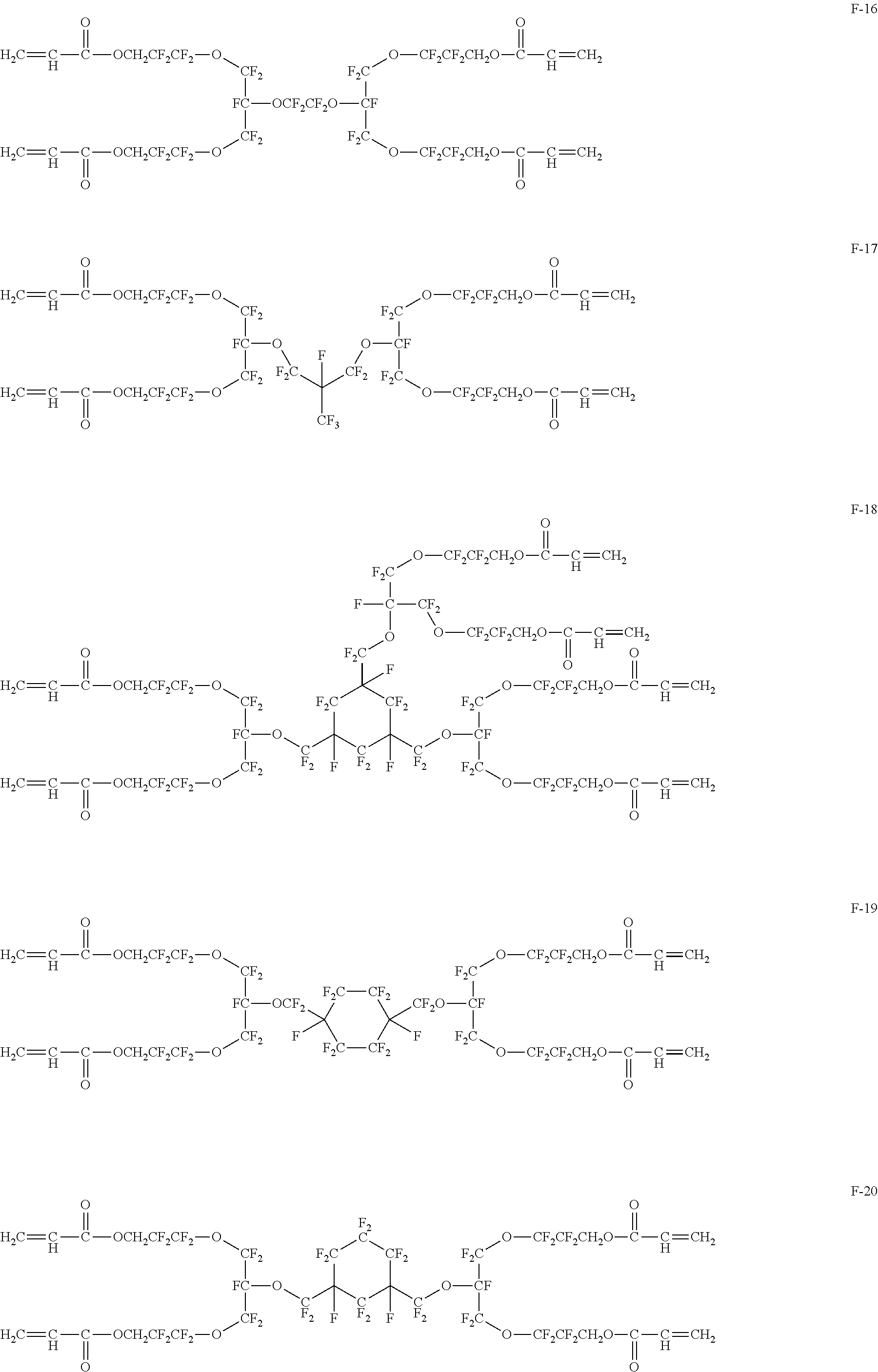

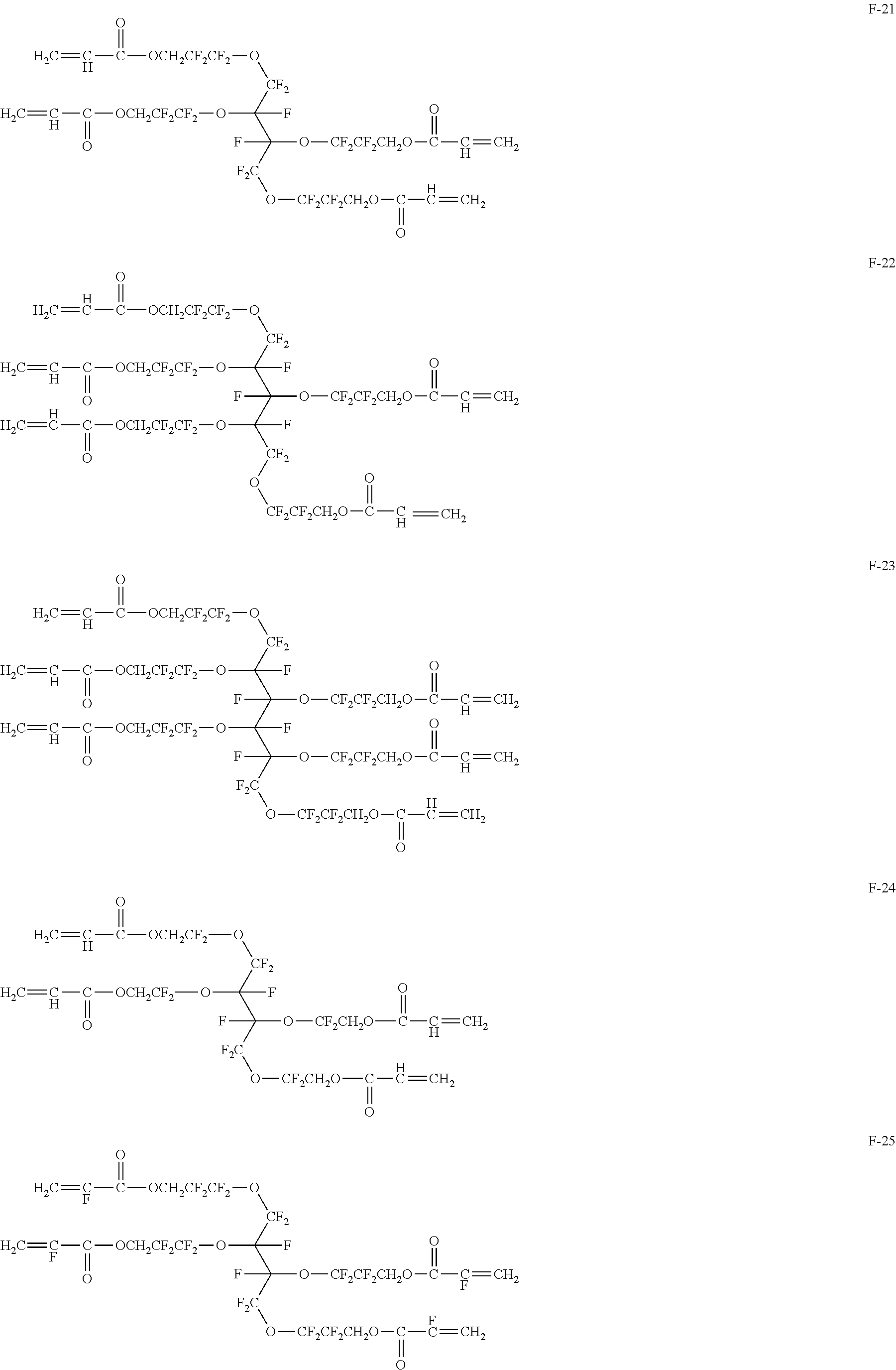

Though a manufacturing method of the polyfunctional fluorine-containing monomer represented by the general formula (I) of the invention is not particularly limited, for example, it can be manufactured by a combination of known methods as described below. In the following description, the already appearing symbols are synonymous with those as described previously unless otherwise indicated.

Step 1: A step of subjecting a compound represented by Rh(CO₂R₁)ₙ or Rh(CH₂OCOR₂)ₙ to a liquid-phase fluorination reaction and a subsequent reaction with methanol as disclosed in U.S. Pat. No. 5,093,432 and WO 00/56694, thereby obtaining a methyl ester Rf(CO₂CH₃)ₙ (wherein R₁ represents a lower alkyl group such as a methyl group and an ethyl group; R₂ represents an alkyl group, preferably a fluorine-containing alkyl group, and more preferably a perfluoroalkyl group; and Rh represents a group capable of becoming Rf through the liquid-phase fluorination reaction).

Step 2: A step of reducing the compound represented by Rf(CO₂CH₃)ₙ with a reducing agent such as lithium aluminum hydride and sodium borohydride, thereby obtaining an alcohol Rf(CH₂OH)ₙ.

Step 3: A step of adding at least one member selected among ethylene carbonate, ethylene oxide and glycidyl alcohol in a block or random form to the compound represented by Rf(CH₂OH)ₙ, thereby obtaining an alcohol Rf(CH₂O-L-F)ₙ.

Step 4: A step of introducing a polymerizable group into the compound represented by Rf(CH₂O-L-H)ₙ, thereby obtaining a compound Rf(CH₂O-L-Y)ₙ represented by the general formula (I). Here, in the case where Y is —COC(R₀)═CH₂, as the polymerizable group-introducing reaction, an esterification reaction of the alcohol Rf(CH₂O-L-H)ₙ with an acid halide XCOC(R₀)═CH₂ (wherein X represents a halogen atom, and preferably a chlorine atom) or dehydration condensation of the alcohol Rf(CH₂O-L-H)ₙ with a carboxylic acid HOCOC(R₀)═CH₂ can be utilized. Also, in the case where Y is other polymerizable group, a nucleophilic substitution reaction between the alcohol Rf(CH₂—O-L-H)ₙ and a corresponding halide compound, or the like can be utilized. The foregoing n is synonymous with n in the general formula (I).

Specific examples of the preferred polyfunctional fluorine-containing monomer in the invention are given below, but it should not be construed that the invention is limited thereof.

Also, nevertheless the polyfunctional fluorine-containing monomer in the invention is hydrophobic, it has a plurality of functional groups having polarity, such as (meth)acrylate, in the same molecule; and thus, its affinity with the hydrophobilized π-conjugated system conductive polymer composition of the invention becomes good, and problems in surface properties such as coagulation to be caused at the time of mixing are hardly caused. On the other hand, in a process in which the composition is coated and the solvent is dried, the polyfunctional fluorine-containing monomer is easy to cause surface segregation, and the π-conjugated system conductive polymer composition is easy to take a bottom segregation structure. The surface-segregated polyfunctional fluorine-containing monomer enhances the scar resistance of the surface; and the bottom-segregated conductive polymer composition is increased in an intermolecular contact frequency and is able to exhibit high conductivity. From the standpoints of an improvement of coating surface properties, an elevation of conductivity and an improvement of scar resistance of the film, in addition to X-2 to X-4, X-6, X-8 to X-14 and X-21 to X-32 disclosed in paragraphs [0023] to [0027] of JP-A-2006-28409, the following compound (X-33) can be preferably used as the polyfunctional fluorine-containing monomer in the invention.

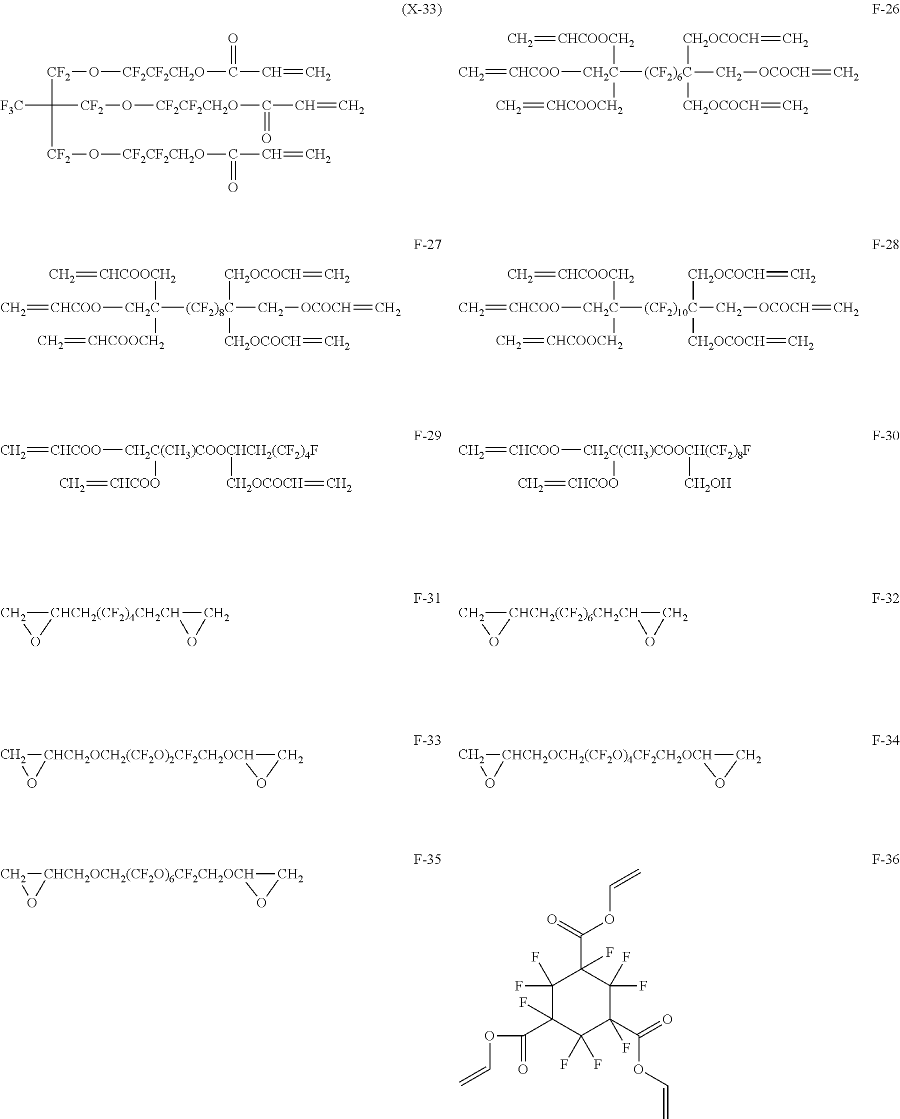

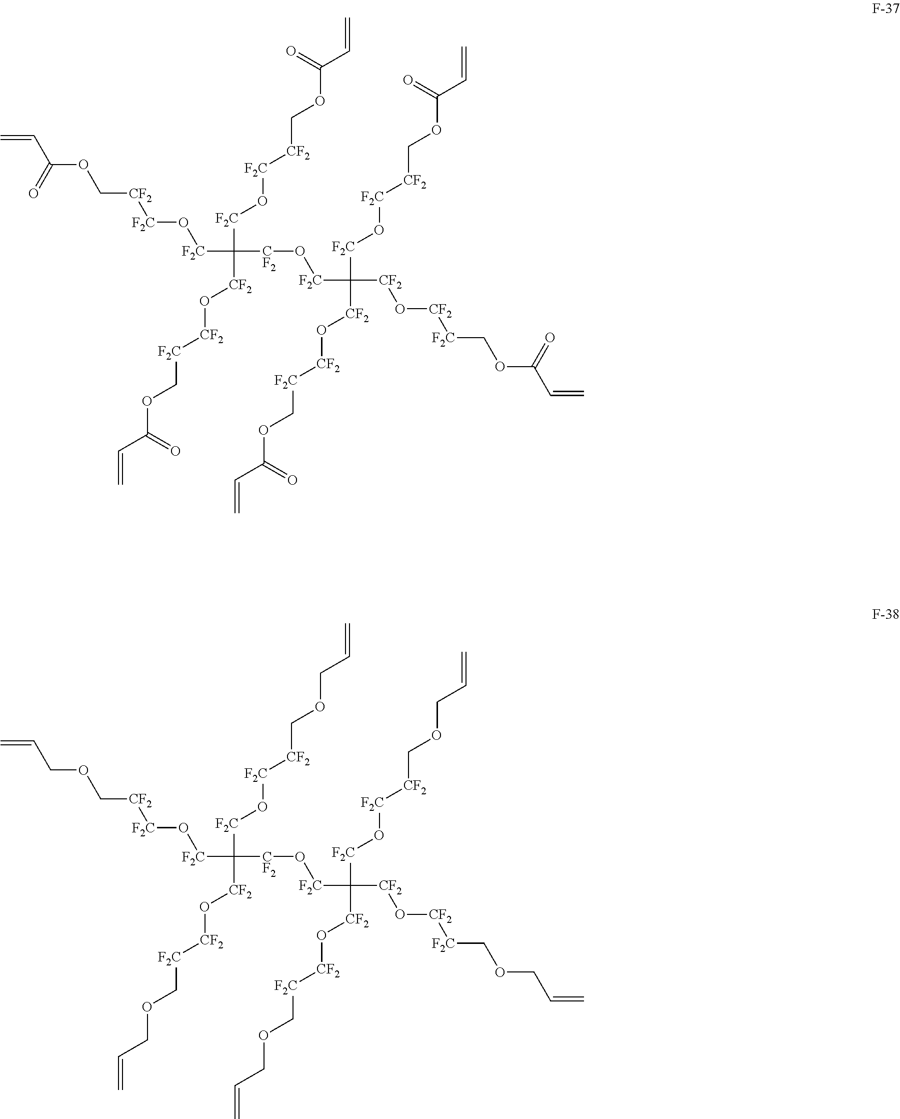

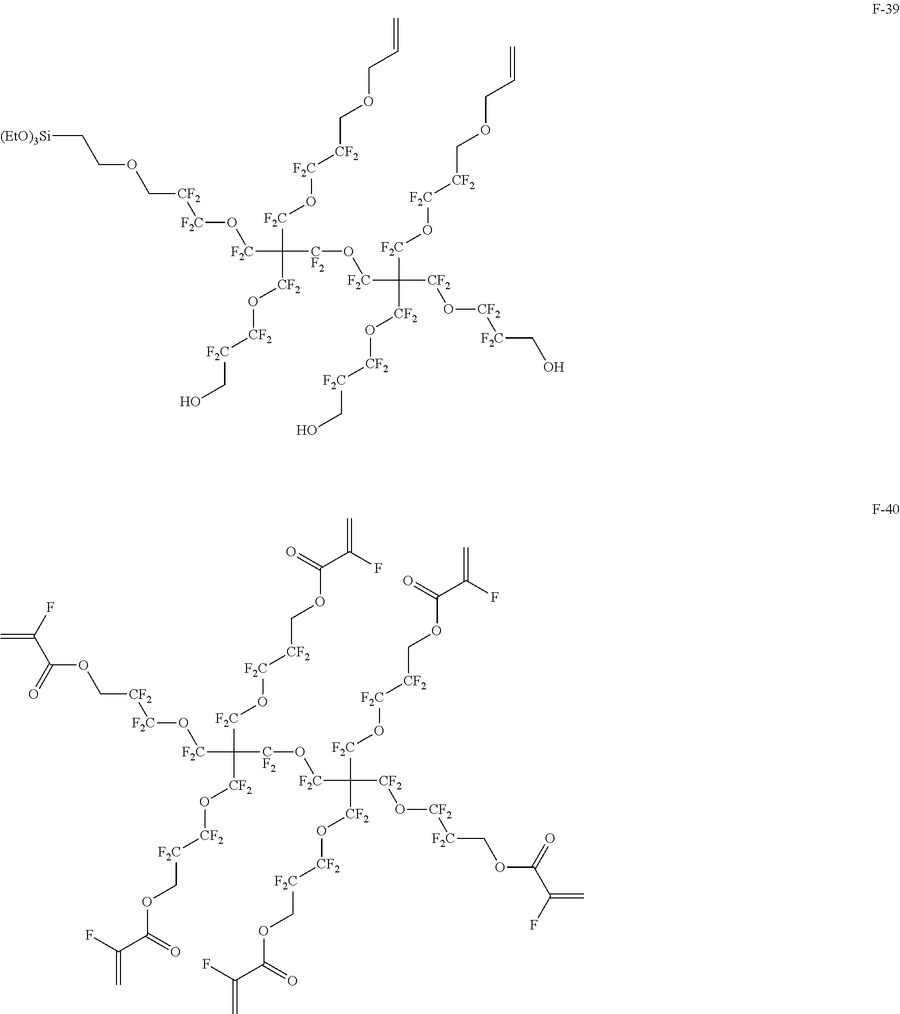

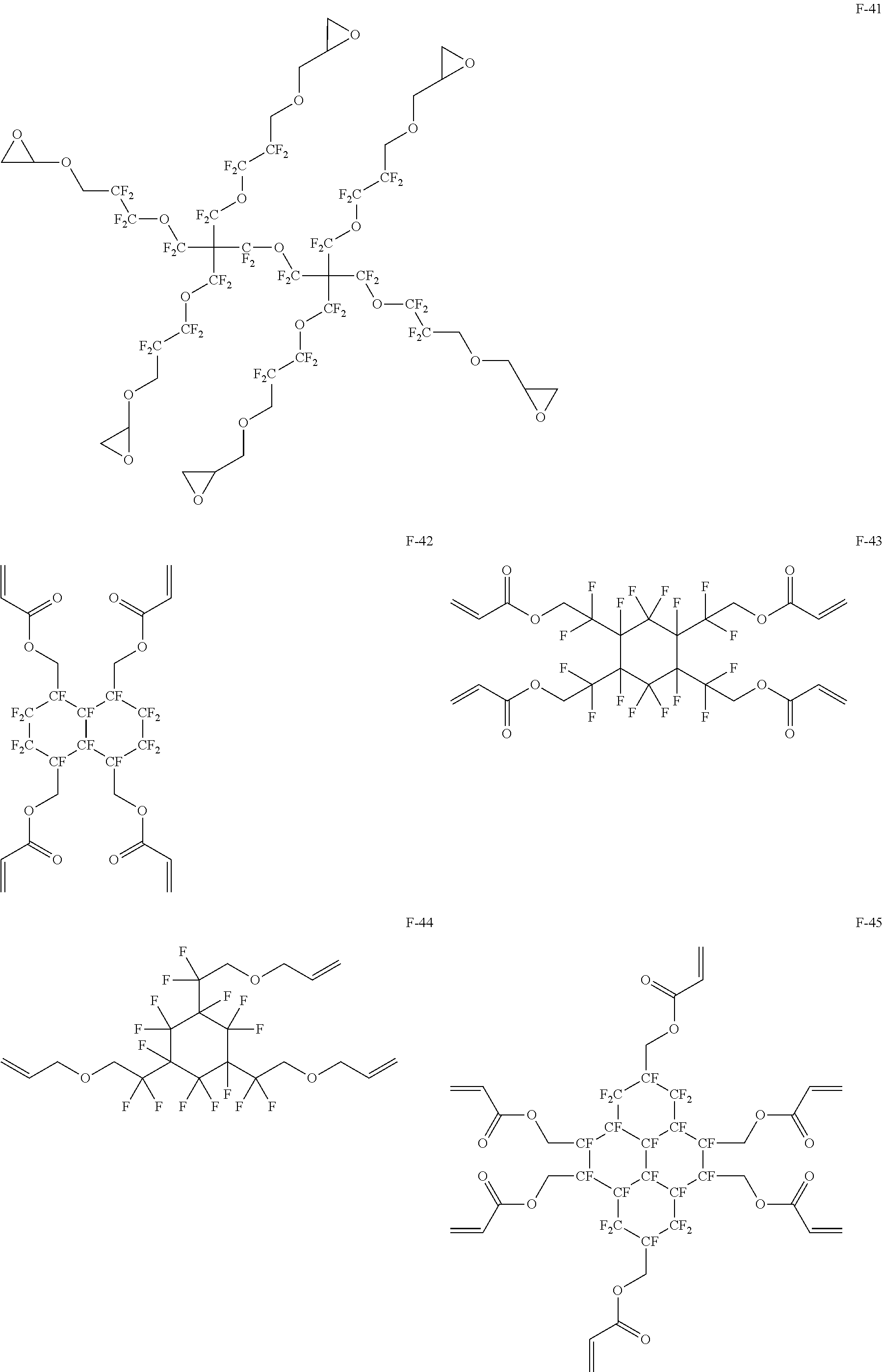

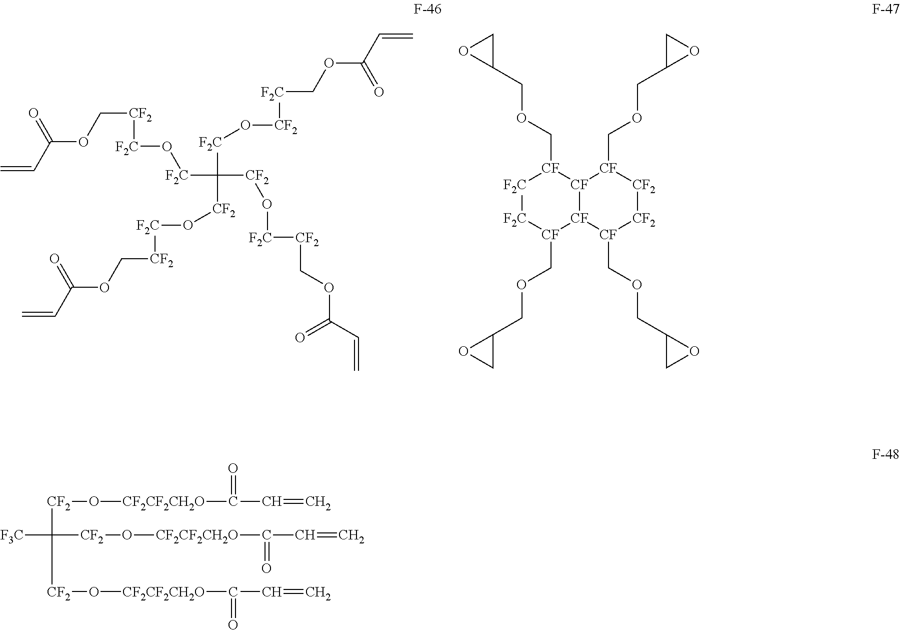

Also, the following compounds can be preferably used.

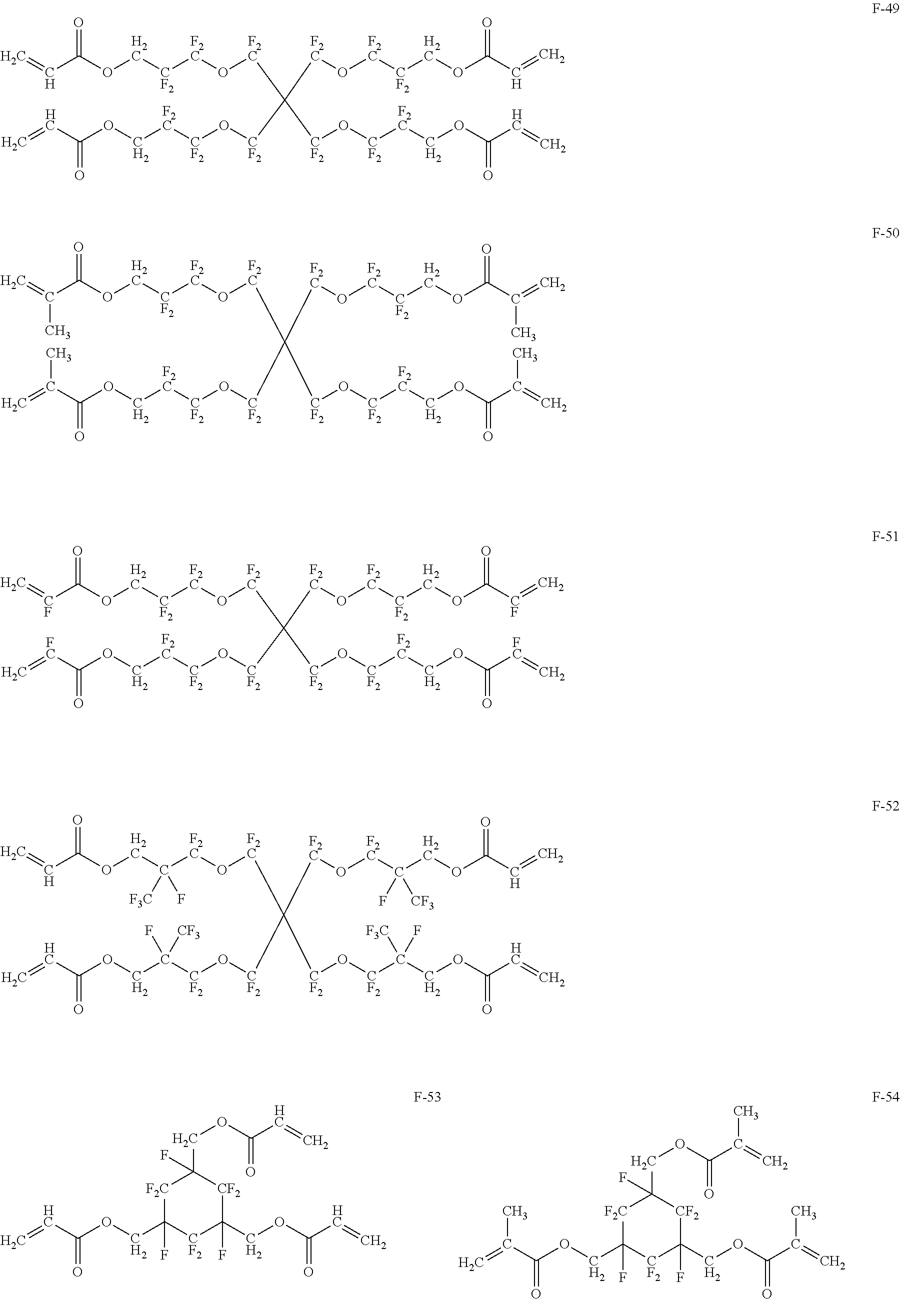

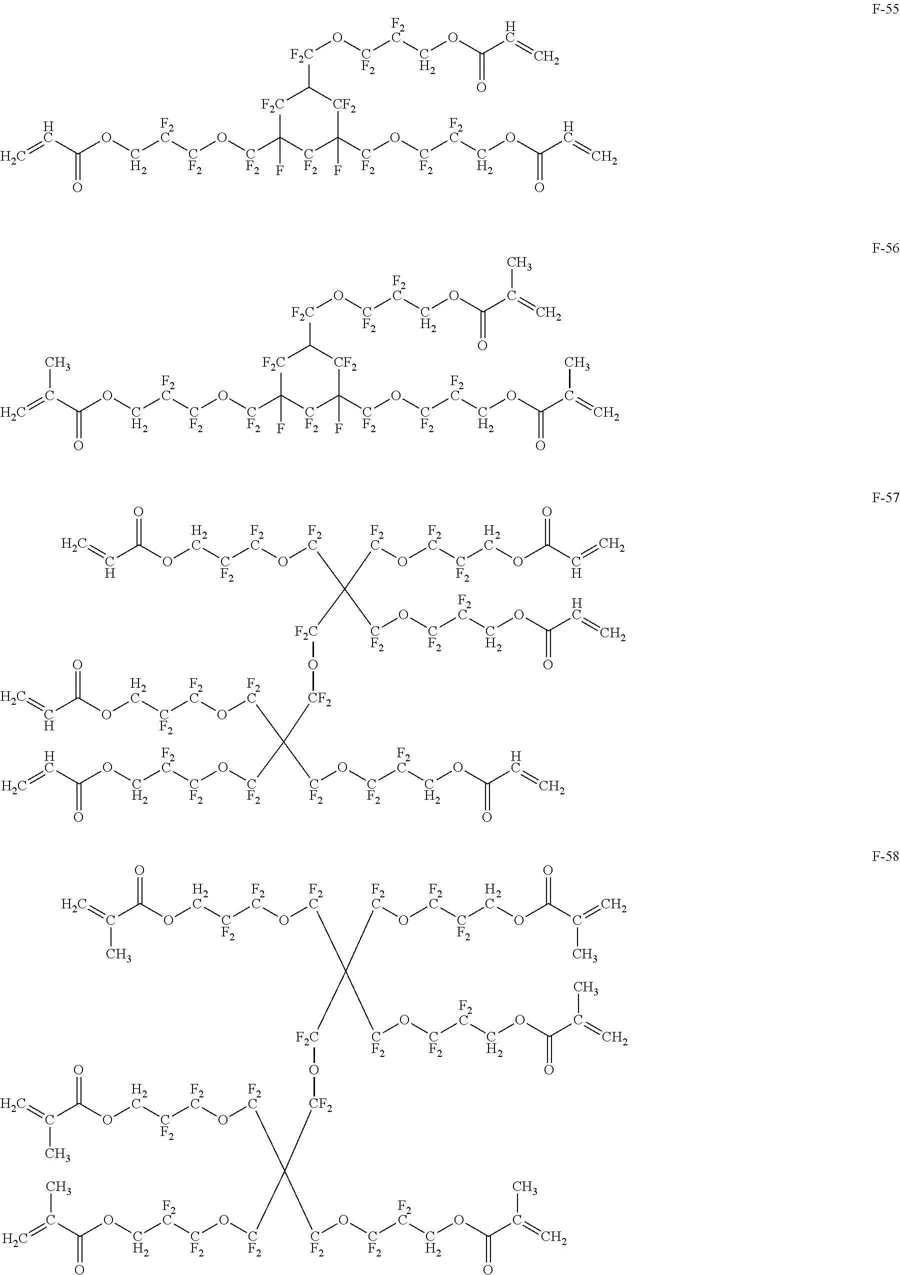

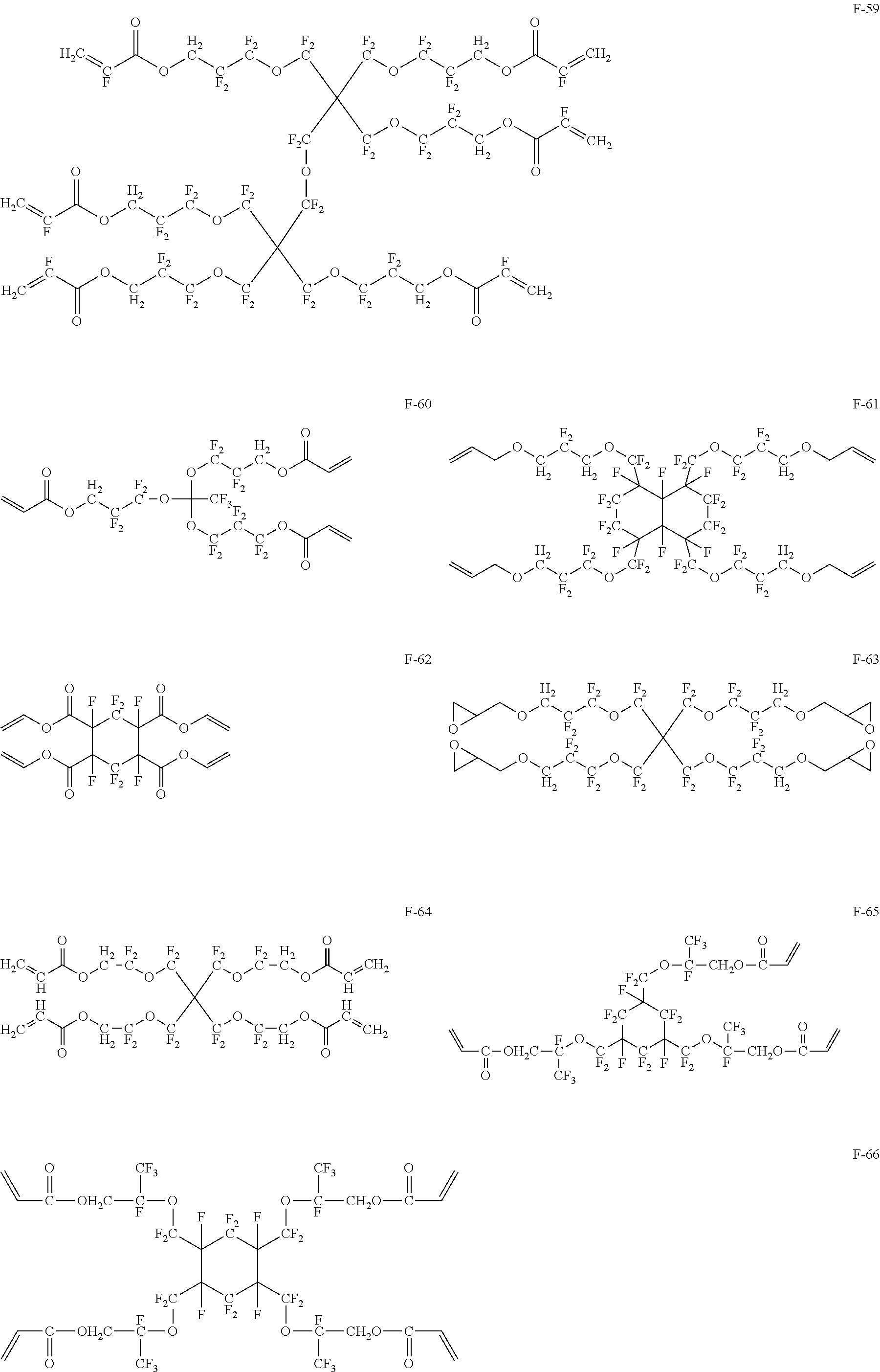

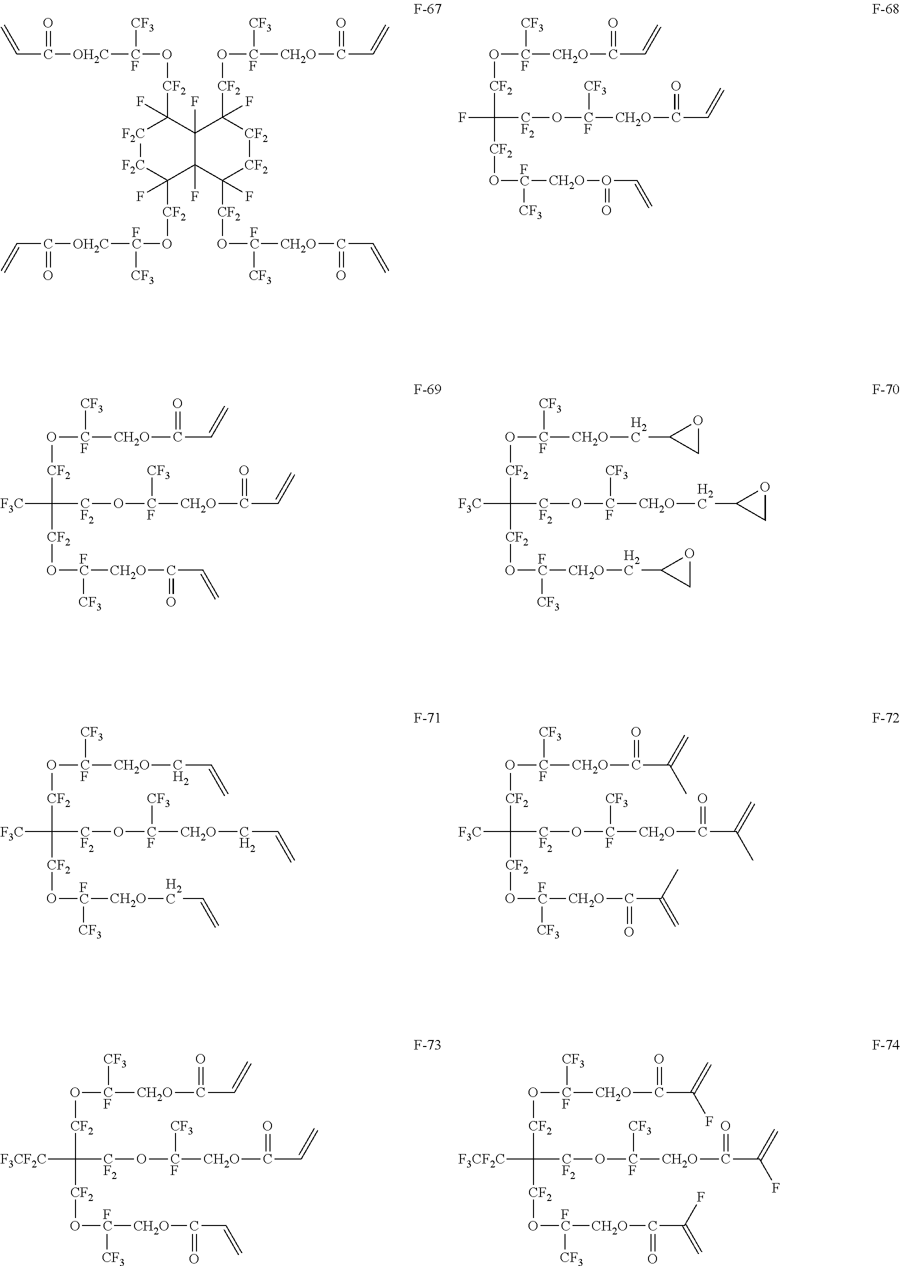

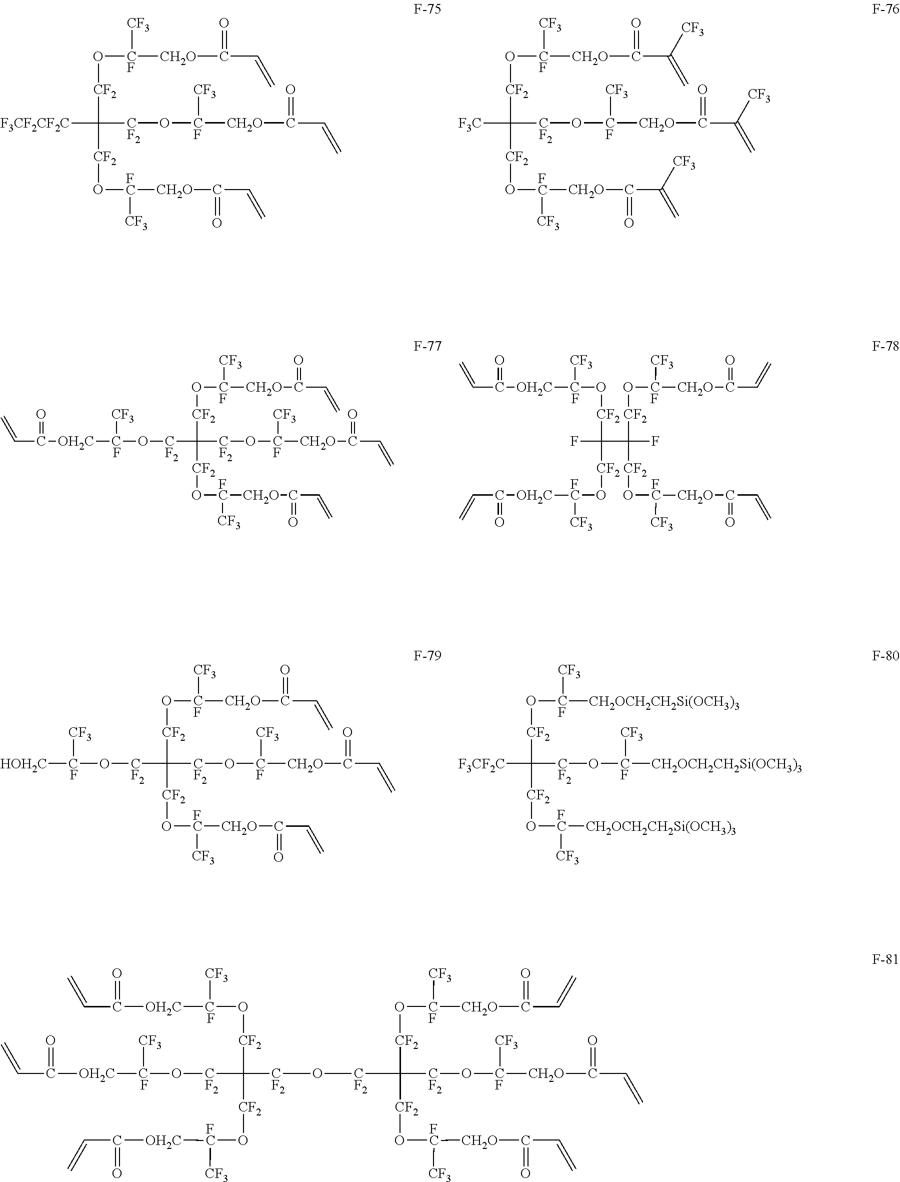

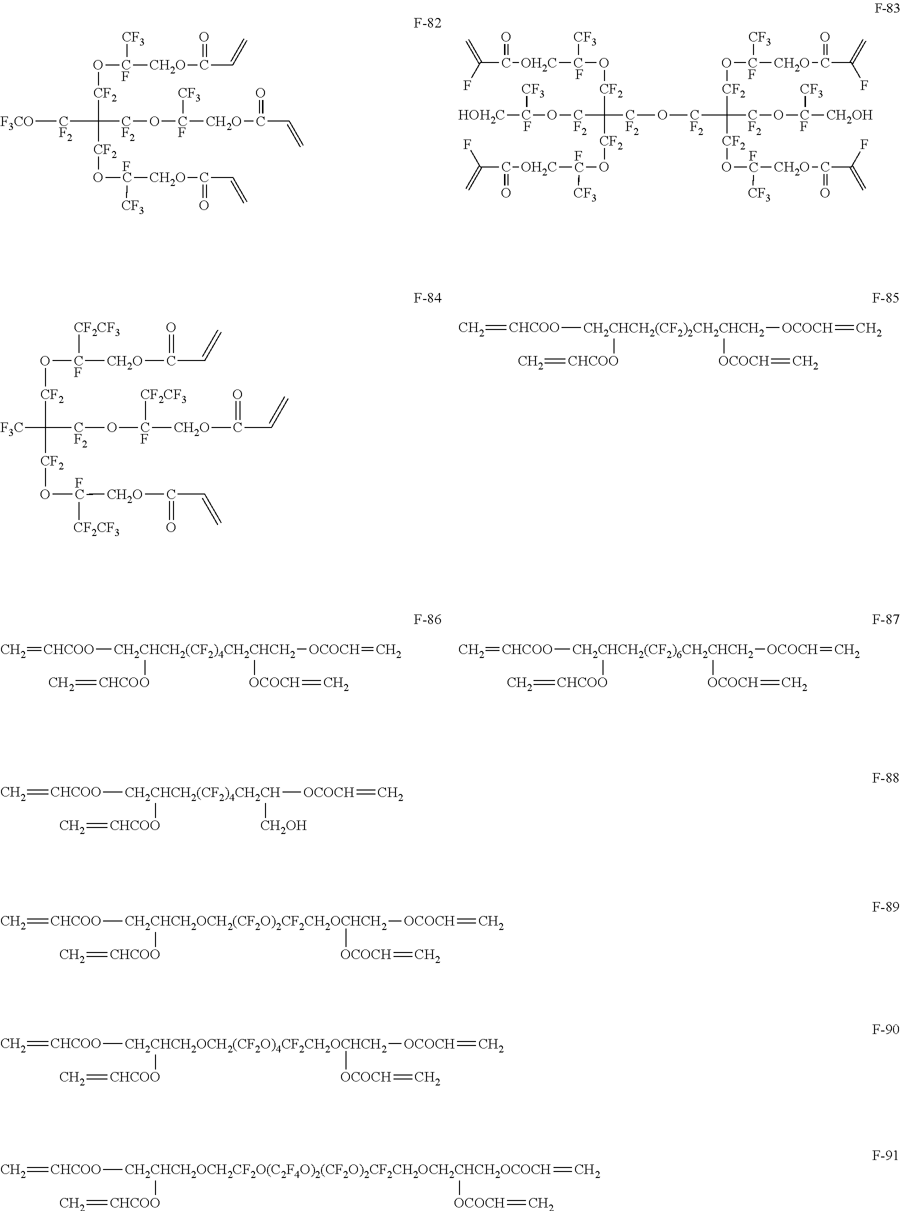

Also, from the standpoints that a crosslinking structure can be formed and that strength and hardness of the cured film are high, the following polyfunctional fluorine-containing (meth)acrylic acid esters can be preferably used as the polyfunctional fluorine-containing monomer in the invention. Specific examples thereof include
1,3-bis{(meth)acryloyloxy}-2,2-difluoropropane,
1,4-bis{(meth)acryloyloxy}-2,2,3,3-tetrafluorobutane,
1,5-bis{(meth)acryloyloxy}-2,2,3,3,4,4-hexafluoropentane,
1,6-bis{(meth)acryloyloxy}-2,2,3,3,4,4,5,5-octafluorohexane,
1,7-bis{(meth)acryloyloxy}-2,2,3,3,4,4,5,5,6,6-decafluoroheptane,
1,8-bis{(meth)acryloyloxy}-2,2,3,3,4,4,5,5,6,6,7,7-dodecafluorooctane,
1,9-bis{(meth)acryloyloxy}-2,2,3,3,4,4,5,5,6,6,7,7,8,8-tetradecafluorononane,
1,10-bis{(meth)acryloyloxy}-2,2,3,3,4,4,5,5,6,6,7,7,8,8,9,9-hexadecafluorodecane,
1,11-bis{(meth)acryloyloxy}-2,2,3,3,4,4,5,5,6,6,7,7,8,8,9,9,10,10-octadecafluoroundecane,
1,12-bis{(meth)acryloyloxy}-2,2,3,3,4,4,5,5,6,6,7,7,8,8,9,9,10,10,11,11-eicosafluorododecane, 1,8-bis{(meth)acryloyloxy}-2,7-dihydroxy-4,4,5,5-tetrafluorooctane,
1,7-bis{(meth)acryloyloxy}-2,8-dihydroxy-4,4,5,5-tetrafluorooctane,
2,7-bis{(meth)acryloyloxy}-1,8-dihydroxy-4,4,5,5-tetrafluorooctane,
1,10-bis{(meth)acryloyloxy}-2,9-dihydroxy-4,4,5,5,6,6,7,7-octafluorodecane,
1,9-bis{(meth)acryloyloxy}-2,10-dihydroxy-4,4,5,5,6,6,7,7-octafluorodecane,
2,9-bis{(meth)acryloyloxy}-1,10-dihydroxy-4,4,5,5,6,6,7,7-octafluorodecane,
1,2,7,8-tetrakis{(meth)acryloyloxy}-4,4,5,5-tetrafluorodecane,
1,2,8,9-tetrakis{(meth)acryloyloxy}-4,4,5,5,6,6-hexafluorononane,
1,2,9,10-tetrakis{(meth)acryloyloxy}-4,4,5,5,6,6,7,7-octafluoroecane,
1,2,10,11-tetrakis {(meth)acryloyloxy}-4,4,5,5,6,6,7,7,8,8-decafluoroundecane,
1,2,11,12-tetrakis {(meth)acryloyloxy}-4,4,5,5,6,6,7,7,8,8,9,9-dodecafluorododecane,
1,10-bis(α-fluoroacryloyloxy)-2,9-dihydroxy-4,4,5,5,6,6,7,7-octafluorodecane,
1,9-bis(α-fluoroacryloyloxy)-2,10-dihydroxy-4,4,5,5,6,6,7,7-octafluorodecane,
2,9-bis(α-fluoroacryloyloxy)-1,10-dihydroxy-4,4,5,5,6,6,7,7-octafluorodecane,
1,2,9,10-tetrakis(α-fluoroacryloyloxy)-4,4,5,5,6,6,7,7-octafluorodecane and
1,2,11,12-tetrakis(α-fluoroacryloyloxy)-4,4,5,5,6,6,7,7,8,8,9,9-dodecafluorododecane.

Such a polyfunctional fluorine-containing (meth)acrylic acid ester can be manufactured by a known method. For example, such a polyfunctional fluorine-containing (meth)acrylic acid ester is manufactured by a ring-opening reaction between a corresponding fluorine-containing epoxy compound and (meth)acrylic acid, or an esterification reaction between a corresponding fluorine-containing polyhydric alcohol or a fluorine-containing (meth)acrylic acid ester having a hydroxyl group obtained as an intermediate in the foregoing ring-opening reaction and (meth)acrylic acid chloride.

Also, from the viewpoint of affinity with other binder or a non-fluorine-containing polyfunctional monomer, a monomer having a repeating unit of an alkyl chain having been substituted with fluorine via an ether bond, which is represented by the following general formula (II), can be used as the polyfunctional fluorine-containing monomer in the invention.

Y—(CF₂—CFX—O)ₙ₂Y General Formula (II)

In the foregoing general formula (II), X represents —F or —CF₃; n2 represents an integer of from 1 to 20; and Y represents a polymerizable group.

A preferred range and specific examples of Y are the same as in Y in the foregoing general formula (I).

Specific examples of the polyfunctional fluorine-containing monomer represented by the general formula (II) are given below, but it should not be construed that the invention is limited thereto.

FP-1: CH₂═CH—COOCH₂(CF₂CF₂—O)₂CH₂OCOCH═CH₂

FP-2: CH₂═CH—COOCH₂(CF₂CF₂—O)₄—CH₂OCOCH═CH₂

FP-3: CH₂═C(CH₃)—COOCH₂(CF₂CF₂—O)₂CH₂OCOC(CH₃)═CH₂

FP-4: CH₂═C(CH₃)—COOCH₂(CF₂C(CF₃)F—O)₄—CH₂OCOC(CH₃)═CH₂

FP-5: CH₂═C(CH₃)—COOCH₂(CF₂C(CF₃)F—O)₈CH₂OCOC(CH₃)═CH₂

The polyfunctional fluorine-containing monomer in the invention is more preferably one represented by the foregoing general formula (I).

### (Fluorine Content of Polyfunctional Fluorine-Containing Monomer)

From the viewpoints of bottom-segregating the π-conjugated system conductive polymer and enhancing the conductivity, a fluorine content of the polyfunctional fluorine-containing monomer of the invention is preferably 25.0% by mass or more, more preferably from 45.0 to 80.0% by mass, and most preferably from 50.0 to 80.0% by mass of the molecular weight of the polyfunctional fluorine-containing monomer. On the other hand, in the case where the fluorine content of the polyfunctional fluorine-containing monomer exceeds 80.0% by mass, though the fluorine atom content in the cured film is high, the strength and hardness of the film are lowered, and the scar resistance and abrasion resistance of the film surface are insufficient.

Also, in order to prepare a high-fluorine content film having excellent conductivity and having a lower refractive index layer, it is preferable that the polyfunctional fluorine-containing monomer has affinity with the π-conjugated system conductive polymer composition, and an oxygen atom-containing polymerizable group such as a (meth)acrylate or epoxy group, or a hydroxyl group existing within the molecule plays a role thereof. What such a structure is contained is preferable from the viewpoints of improving surface properties of a coating film and enhancing stability with time of a coating solution.

A content of the polyfunctional fluorine-containing monomer is preferably from 10 to 90% by mass, more preferably from 12 to 60% by mass, and further preferably from 15 to 50% by mass relative to the whole of solids in the composition.

As to the composition for low refractive index layer in the invention, in addition to the foregoing polyfunctional fluorine-containing monomer (A) having a polymerizable group, by jointly using a non-fluorine-containing polyfunctional monomer, an antireflection film having a lower refractive index, having excellent scar resistance and further having excellent antifouling properties and durability can be obtained.

### (Non-Fluorine-Containing Polyfunctional Monomer)

As the non-fluorine-containing polyfunctional monomer, there is exemplified a compound not containing a fluorine atom and having two or more polymerizable groups in one molecule. As the polymerizable group, the same polymerizable groups as those described in the foregoing polyfunctional fluorine-containing monomer (A) having a polymerizable group can be exemplified, and a preferred range thereof is also the same. In particular, a (meth)acryloyl group is the most preferable. When the fluorine content of the monomer for forming a binder for the purpose of decreasing the refractive index of the low refractive index layer, a density of the crosslinking group in the film decreases, the strength of the film becomes low, and the scar resistance tends to be lowered. Also, the polyfunctional fluorine-containing monomer and the π-conjugated system conductive polymer are not always sufficient in the affinity because the polarity is largely different from each other. For that reason, in coating a coating solution containing an organic solvent and drying it to form the low refractive index layer, an interfacial bond between the π-conjugated system conductive polymer and the polyfunctional fluorine-containing monomer is weak, and the strength of the coating film after curing is easily lowered. In particular, in the low refractive index layer which is the outermost surface of the antireflection film, it is easily influenced by polymerization inhibition due to oxygen at the time of curing, and there is a tendency that curing becomes weaker. In the invention, by jointly using the non-fluorine-containing polyfunctional monomer, the affinity between the π-conjugated system conductive polymer and the polyfunctional fluorine-containing monomer is further improved, and the strength of the film is increased, whereby the scar resistance can be enhanced.

Examples of the non-fluorine-containing polyfunctional monomer having two or more (meth)acryloyl groups include (meth)acrylic acid diesters of a polyhydric alcohol; and (meth)acrylic acid diesters of an ethylene oxide or propylene oxide adduct. Specific examples of such a (meth)acrylic acid diester are disclosed in paragraph [0116] of JP-A-2009-098658, and these materials can also be suitably used in the invention.

Furthermore, (meth)acrylates, urethane (meth)acrylates and polyester (meth)acrylates are preferably used as the photopolymerizable polyfunctional monomer.

Above all, esters of a polyhydric alcohol and (meth)acrylic acid are preferable. Polyfunctional monomers having three or more (meth)acryloyl groups are more preferable. Specific examples of such an ester are disclosed in paragraph [0118] of JP-A-2009-098658, and these materials can also be suitably used in the invention.

Of these compounds, those containing a hydroxyl group, an amide group, an ethylene oxide group or a propylene oxide group in a molecule thereof are preferable. The compound having such a functional group is excellent in the affinity between the π-conjugated system conductive polymer and the polyfunctional fluorine-containing monomer according to the invention and is able to improve surface properties of a coating film, enhance stability with time of a coating solution, increase a hardness of the low refractive index layer and improve scar resistance.

As the polyfunctional acrylate based compound having a (meth)acryloyl group, commercially available products can be used, and for example, DHPA, manufactured by Nippon Kayaku Co., Ltd. can be exemplified. Also, those disclosed in paragraph [0119] of JP-A-2009-098658 can be suitably used.

Among the compounds containing a polymerizable unsaturated group which is preferably used as the polymerizable group, from the standpoint of the affinity between the π-conjugated system conductive polymer composition and the polyfunctional fluorine-containing monomer, it is preferable to use a compound containing at least one member selected among a glycidyl group and/or a hydroxyl group, a methacryl group, an acryl group, a methacrylamide group and an acrylamide group in a molecule thereof. Specific examples of such a compound include those described below.

Examples of a compound having a glycidyl group and a methacryl group (acryl group) include glycidyl methacrylate and glycidyl acrylate.

Examples of a compound having a hydroxyl group and a methyl group, an acryl group, a methacrylamide group or an acrylamide group include 2-hydroxyethyl methacrylate, 2-hydroxyethyl acrylate, 2-hydroxypropyl methacrylate, 2-hydroxypropyl acrylate, 4-hydroxybutyl methacrylate, 4-hydroxybutyl acrylate, ethyl-α-hydroxymethyl acrylate, pentaerythritol triacrylate, dipentaerythritol monohydroxypentaacrylate, 2-hydroxyethyl acrylamide and 2-hydroxyethyl methacrylamide. Such a compound may be used singly, or may be used in admixture of two or more kinds thereof. Of the foregoing illustrative compounds, 2-hydroxyethyl acrylamide, 2-hydroxyethyl methacrylamide, 2-hydroxyethyl acrylate and dipentaerythritol monohydroxypentaacrylate are preferable because the affinity with the conductive polymer composition in the invention is high, with 2-hydroxyethyl acrylamide being more preferable. Such a compound is excellent in surface properties of a coating film, is able to enhance a crosslinking density of the transparent conductive layer and is able to enhance heat resistance, resistance to high temperature and high humidity and scar resistance.

Furthermore, there are exemplified resins having three or more (meth)acryloyl groups, for example, relatively low-molecular weight polyester resins, polyether resins, acrylate resins, epoxy resins, urethane resins, alkyd resins, spiro acetal resins, polybutadiene resins, polythiol polyene resins and oligomers or polymers of a polyfunctional compound such as a polyhydric alcohol, and the like. As the non-fluorine-containing polyfunctional monomer, dendrimers disclosed in, for example, JP-A-2005-76005 and JP-A-2005-36105 and norbornene ring-containing monomers disclosed in, for example, JP-A-2005-60425 can also be used.

The non-fluorine-containing functional monomer may be used in combinations of two or more kinds thereof.

An addition amount of the non-fluorine-containing functional monomer is preferably from 0.1 to 50% by mass, more preferably from 1 to 30% by mass, and especially preferably from 3 to 20% by mass relative to the whole of solids in the composition for low refractive index layer. So far as the non-fluorine-containing functional monomer is used within this range, it is possible to achieve an elevation of a hardness of the low refractive index layer, fixation of an antifouling agent as described later in the surface layer of the low refractive index layer and an improve in interfacial adhesion to an adjacent layer.

Also, an oligomer or polymer having a polymerizable group may be used.

The hydrophobilized conductive polymer composition (B) containing a π-conjugated system conductive polymer and an anion group-containing polymer dopant in the invention (such a composition will be also referred to as “conductive polymer composition”) is hereunder described in detail.

### ((B) Hydrophobilized Conductive Polymer Composition (B) Containing a π-Conjugated System Conductive Polymer and an Anion Group-Containing Polymer Dopant)

The conductive polymer composition in the invention contains a π-conjugated system conductive polymer and an anion group-containing polymer dopant. The conductive polymer composition is one having been subjected to a hydrophobilization treatment and preferably contains an organic solvent and forms a uniform solution as a whole.

The term “hydrophobilized” as referred to herein means that the conductive polymer composition is soluble in an organic solvent having a relative dielectric constant of from 2 to 30 and a water content of not more than 5% by mass in a degree of at least 1.0% by mass (solids concentration) at 20° C. The relative dielectric constant as referred to herein means a ratio of a dielectric constant of the organic solvent and a dielectric constant of vacuum and is measured at 20° C. Also, in the invention, the phrase “the conductive polymer composition is soluble” refers to a state where the π-conjugated system conductive polymer and the polymer dopant are dissolved in a single molecule state or in a state where a plurality of single molecules are associated, or it is dispersed in a particulate form having a particle size of not more than 300 nm. The “organic solvent” as referred to herein means a compound which after a coating composition of the invention is coated and dried, is substantially vaporized from the coating film and removed.

In general, the π-conjugated system conductive polymer is high in hydrophilicity and is dissolved in a solvent composed mainly of water. However, in the invention, the π-conjugated system conductive polymer is made soluble in the foregoing specified organic solvent through a hydrophobilization treatment as described later. Also, by performing the hydrophobilization treatment, its affinity with the polyfunctional fluorine-containing monomer is enhanced, thereby enabling one to form an antireflection film having a low surface resistivity.

In the invention, it is preferable that the conductive polymer composition is soluble in the organic solvent in a degree of at least 1.0% by mass at 20° C. In the case where the conductive polymer composition is present in a particulate form in the organic solvent, its average particle size is not more than 300 nm, preferably not more than 200 nm, and more preferably not more than 100 nm. In order to remove coarse particles or accelerate dissolution, a high-pressure dispersion machine can also be used. Examples of the high-pressure dispersion machine include Gaulin (manufactured by APV Gaulin), Nanomizer (manufactured by Nanomizer Inc.), Microfluidizer (manufactured by Microfluidics), Multimizer (manufactured by Sugino Machine Limited) and DeBee (manufactured by Bee). The particle size can be observed after scooping up an organic solvent solution on a grid for electron microscopic observation and vaporizing the solvent. So far as the particle size falls within the foregoing range, since sedimentation in the organic solvent is suppressed, a composition for low refractive index layer containing such a conductive polymer composition is suitably useful as a coating solution.

### (π-Conjugated System Conductive Polymer)

The π-conjugated system conductive polymer is not particularly limited so far as it is an organic polymer whose main chain is constituted of a π-conjugated system. The π-conjugated system conductive polymer is preferably a π-conjugated system heterocyclic compound or a derivative of a π-conjugated system heterocyclic compound for the reasons that it exhibits high conductivity, is low in coloration and is high in stability of the compound.

Examples of the π-conjugated system conductive polymer include polypyrroles, polythiophenes, polyacetylenes, polyphenylenes, polyphenylvinylenes, polyanilines, polyacenes and polythiophenevinylenes. From the standpoint of stability in air, polypyrroles, polythiophenes and polyanilines are preferable; and polythiophenes and polyanilines are more preferable. Polythiophene and polythiophene derivatives are generically named “polythiophenes”. The same is also applicable to the others.

Even when the π-conjugated system conductive polymer is unsubstituted, sufficient conductivity and affinity with a binder resin are obtainable. However, in order to more enhance the conductivity and affinity, it is preferable to introduce a functional group such as an alkyl group, a carboxy group, a sulfo group, an alkoxy group and a hydroxyl group into the π-conjugated system conductive polymer.

Specific examples of the π-conjugated system conductive polymer include:

polypyrroles such as polypyrrole, poly(N-methylpyrrole), poly(3-methylpyrrole), poly(3-ethylpyrrole), poly(3-n-propylpyrrole), poly(3-butylpyrrole), poly(3-octylpyrrole), poly(3-decylpyrrole), poly(3-dodecylpyrrole), poly(3,4-dimethylpyrrole), poly(3,4-dibutylpyrrole), poly(3-carboxypyrrole), poly(3-methyl-4-carboxypyrrole), poly(3-methyl-4-carboxyethylpyrrole), poly(3-methyl-4-carboxybutylpyrrole), poly(3-hydroxypyrrole), poly(3-methoxypyrrole), poly(3-ethoxypyrrole), poly(3-butoxypyrrole) and poly(3-methyl-4-hexyloxypyrrole);

polythiophenes such as poly(thiophene), poly(3-methylthiophene), poly(3-ethylthiophene), poly(3-propylthiophene), poly(3-butylthiophene), poly(3-hexylthiophene), poly(3-heptylthiophene), poly(3-octylthiophene), poly(3-decylthiophene), poly(3-dodecylthiophene), poly(3-octadecylthiophene), poly(3-bromothiophene), poly(3-chlorothiophene), poly(3-iodothiophene), poly(3-cyanothiophene), poly(3-phenylthiophene), poly(3,4-dimethylthiophene), poly(3,4-dibutylthiophene), poly(3-hydroxythiophene), poly(3-methoxythiophene), poly(3-ethoxythiophene), poly(3-butoxythiophene), poly(3-hexyloxythiophene), poly(3-heptyloxythiophene), poly(3-octyloxythiophene), poly(3-decyloxythiophene), poly(3-dodecyloxythiophene), poly(3-octadecyloxythiophene), poly(3-methyl-4-methoxythiophene), poly(3,4-ethylenedioxythiophene), poly(3-methyl-4-ethoxythiophene), poly(3-carboxythiophene), poly(3-methyl-4-carboxythiophene), poly(3-methyl-4-caboxyethylthiophene) and poly(3-methyl-4-carboxybutylthiophene); and

polyanilines such as polyaniline, poly(2-methylaniline), poly(3-isobutylaniline), poly(2-anilinesulfonic acid) and poly(3-anilinesulfonic acid).

A content of the π-conjugated system conductive polymer is preferably from 1% by mass to 60% by mass, and more preferably from 2% by mass to 30% by mass relative to the whole of solids of the low refractive index layer. So far as the content of the π-conjugated system conductive polymer is 1% by mass or more, a common logarithm log(SR) of a surface resistivity SR (Ω/sq) of the antireflection film can be regulated to not more than 13.0, and the antireflection film is excellent in dustproof properties. So far as the content of the π-conjugated system conductive polymer is not more than 60% by mass, the reflectance of the antireflection film can be sufficiently lowered, and the strength of the low refractive index layer can be enhanced.

In general, though the refractive index of the π-conjugated system conductive polymer is not low as compared with that of the polyfunctional fluorine-containing monomer, it is from about 1.48 to 1.65, and preferably not more than 1.60.

A molecular weight of the π-conjugated system conductive polymer is preferably from 1,000 to 1,000,000, and more preferably from 5,000 to 500,000. In the case where the conductive polymer is present in a particulate form, an average particle size is preferably from 5 to 300 nm, and more preferably from 10 to 150 nm. Also, the particle may be monodispersed or polydispersed.

### (Maldistribution (Uneven Distribution) of π-Conjugated System Conductive Polymer)

In the antireflection film of the invention, it is preferable that the π-conjugated system conductive polymer is maldistributed in a film thickness direction of the low refractive index layer.

The fluorine atom has high binding energy to the carbon atom, is stable and exhibits a low polarizability (dynamic polarizability) such that it is hardly externally induced, and thus, the refractive index and the relative dielectric constant are lowered. Furthermore, what the polarizability is low means that an intermolecular force is weak; and the fluorine-containing compound exhibits a low surface tension against other compounds and has properties such that it is easy to cause surface maldistribution. For that reason, after the composition for low refractive index layer containing the π-conjugated system conductive polymer is coated on a support, followed by drying the organic solvent, the polyfunctional fluorine-containing monomer (A) in the invention can be maldistributed in an upper part (side far from the support) within the coating film, and the π-conjugated system conductive polymer can be maldistributed in a bottom (support side) within the coating film.

By maldistributing the π-conjugated system conductive polymer in a bottom (support side), a distance between the π-conjugated system conductive polymers is shortened, and a three-dimensional network structure can be easily constructed; and therefore, an enhancement of conductivity and an enhancement of surface properties of the coating film can be attained. The degree of bottom maldistribution can be controlled by a structure of each of the components, a composition ratio and the like in the composition for low refractive index layer. The degree of bottom maldistribution can be evaluated by (bottom maldistribution ratio)=[mass of the π-conjugated system conductive polymer existing in a film thickness region of from a center of the low refractive index layer to the surface of the low refractive index layer contacting with support]÷[total mass of the π-conjugated system conductive polymers existing in the whole of the low refractive index layer]×100(%).

The bottom maldistribution ratio is preferably from 55 to 100%, more preferably from 60 to 100%, and most preferably from 70 to 100%.

In the invention, in the case of coating the composition for low refractive index layer and then drying the organic solvent, when the bottom maldistribution is advanced due to the structure of the polyfunctional fluorine-containing monomer or a composition of coexisting additives, there may be the case where a layer configuration in which separation into two layers having a different refractive index from each other is caused is revealed. Even in such case, in the invention, the whole of the coating film formed of the foregoing composition for low refractive index layer is referred to as the low refractive index layer.

The maldistribution properties in a film thickness direction can be evaluated by an oblique cutting TOF-SIMS measurement (time of flight secondary ion mass spectrometry).

### (Anion Group-Containing Polymer Dopant)

As the anion group-containing polymer dopant (also referred to as “polyanion dopant”), there is exemplified a polymer having at least one structure of a substituted or unsubstituted polyalkylene, a substituted or unsubstituted polyalkenylene, a substituted or unsubstituted polyimide, a substituted or unsubstituted polyamide and a substituted or unsubstituted polyester and containing an anion group-containing structural unit.

The polyalkylene as referred to herein is a polymer whose main chain is constituted of a methylene repeating unit. Examples of the polyalkylene include polyethylene, polypropylene, polybutene, polypentene, polyhexene, polyvinyl alcohol, polyvinylphenol, poly(3,3,3-trifluoropropylene), polyacrylonitrile, polyacrylates and polystyrene.

The polyalkenylene as referred to herein is a polymer composed of a structural unit containing an unsaturated double bond (vinyl group) in a main chain thereof.

Examples of the polyimide include polyimides composed of an acid anhydride (for example, pyromellitic acid dianhydride, biphenyltetracarboxylic acid dianhydride, benzophenonetetracarboxylic acid dianhydride, 2,2′-[4,4′-di(dicarboxyphenyloxy)phenyl]propane dianhydride, etc.) and a diamine (for examples, oxydiamine, p-phenylenediamine, m-phenylenediamine, benzophenonediamine, etc.).

Examples of the polyamide include polyamide 6, polyamide 6,6 and polyamide 6,10.

Examples of the polyester include polyethylene terephthalate and polybutylene terephthalate.

In the case where the foregoing polyanion dopant has a substituent, examples of the substituent include an alkyl group, a hydroxyl group, an amino group, a carboxy group, a cyano group, a phenyl group, a phenol group, an ester group and an alkoxy group. When solubility in an organic solvent, heat resistance, affinity with a binder resin and the like are taken into consideration, an alkyl group, a hydroxyl group, a phenol group and an ester group are preferable.

Examples of the alkyl group include chain (linear or branched) alkyl groups such as methyl, ethyl, propyl, butyl, isobutyl, t-butyl, pentyl, hexyl, octyl, decyl and dodecyl; and cycloalkyl groups such as cyclopropyl, cyclopentyl and cyclohexyl.

Examples of the hydroxyl group include a hydroxyl group bonded to the main chain of the polyanion dopant directly or via other functional group. Examples of other functional group include an alkyl group having from 1 to 7 carbon atoms, an alkenyl group having from 2 to 7 carbon atoms, an amide group and an imide group. The hydroxyl group is substituted on an end of or in such a functional group.

Examples of the amino group include an amino group bonded to the main chain of the polyanion dopant directly or via other functional group. Examples of other functional group include an alkyl group having from 1 to 7 carbon atoms, an alkenyl group having from 2 to 7 carbon atoms, an amide group and an imide group. The amino group is substituted on an end of or in such a functional group.

Examples of the phenol group include a phenol group bonded to the main chain of the polyanion dopant directly or via other functional group. Examples of other functional group include an alkyl group having from 1 to 7 carbon atoms, an alkenyl group having from 2 to 7 carbon atoms, an amide group and an imide group. The phenol group is substituted on an end of or in such a functional group.

Any anion group is useful as the anion group of the polyanion dopant so far as it is able to be oxidized and doped into the π-conjugated system conductive polymer compound, and examples thereof include a sulfate group, a phosphate group, a sulfo group, a carboxy group and a phospho group. —O—SO₃⁻X⁺, —SO₃⁻X⁺ and —COO⁻X⁺ (wherein X⁺ represents a hydrogen ion or an alkali metal ion) are preferable.

Of these, —SO₃⁻X⁺ and —COO⁻X⁺ are more preferable from the standpoint of doping ability into the 71-conjugated system conductive polymer.

Of the foregoing polyanion dopants, polyisoprenesulfonic acid, a copolymer containing polyisoprenesulfonic acid, polysulfoethyl methacrylate, a copolymer containing polysulfoethyl methacrylate, poly(4-sulfobutyl methacrylate), a copolymer containing poly(4-sulfobutyl methacrylate), polymethacryloxybenzenesulfonic acid, a copolymer containing polymethacryloxybenzenesulfonic acid, 2-acrylamide-methylpropanesulfonic acid, a copolymer containing 2-acrylamide-methylpropanesulfonic acid, polystyrenesulfonic acid and a copolymer containing polystyrenesulfonic acid are preferable from the standpoints of solvent solubility and conductivity.

Also, for the purpose of enhancing the solubility in an organic solvent, it is preferable to use a component having a structure selected among a polyalkylene glycol structure, a polystyrene derivative structure, a poly(meth)acrylic acid derivative structure and a poly(meth)acrylonitrile structure as the component capable of being copolymerized with the foregoing anion group.

As to a degree of polymerization of the polyanion dopant, a monomer unit number is preferably in the range of from 10 to 100,000, and it is more preferably in the range of from 50 to 10,000 from the standpoints of solvent solubility and conductivity. A molecular weight of the polyanion dopant is preferably in the range of from 1,000 to 30,000,000, and more preferably in the range of from 5,000 to 300,000.

A content of the polyanion dopant is preferably in the range of from 0.1 to 10 moles, and more preferably in the range of from 1 to 7 moles per mole of the π-conjugated system conductive polymer. Here, the molar number is defined by a structural unit number derived from an anion group-containing monomer capable of forming the polyanion dopant and a structural unit number derived from a monomer capable of forming the π-conjugated system conductive polymer, such as pyrrole, thiophene and aniline. So far as the content of the polyanion dopant is 0.1 moles or more per mole of the π-conjugated system conductive polymer, a doping effect into the π-conjugated system conductive polymer becomes large, and the conductivity is sufficiently revealed. In addition, the dispersibility and solubility in a solvent becomes high, and it is easy to obtain a uniform dispersion. Also, so far as the content of the polyanion dopant is not more than 10 moles per mole of the π-conjugated system conductive polymer, a large amount of the π-conjugated system conductive polymer can be contained, and sufficient conductivity is easily obtainable.

A refractive index of the polyanion dopant is from about 1.48 to 1.65, and what the refractive index of the polyanion dopant is not more than 1.60 is preferable in the case of using it for the low refractive index layer. A total content of the π-conjugated system conductive polymer and the polyanion dopant in the composition for low refractive index layer is preferably from 0.05 to 5% by mass, and more preferably from 0.5 to 4.0% by mass relative to the total mass of the whole of solids and the solvent in the composition. So far as the total content of the π-conjugated system conductive polymer and the polyanion dopant is 0.05% by mass or more, sufficient conductivity is obtainable. So far as the total content of the π-conjugated system conductive polymer and the polyanion dopant is not more than 5% by mass, gelation or deterioration of coating surface properties hardly occurs.

Though a combination of the π-conjugated system conductive polymer and the polyanion dopant is not particularly limited, examples thereof include polyethylenedioxythiophene.polystyrenesulfonic acid (PEDOT.PSS), polyethylenedioxythiophene.polyisoprenesulfonic acid, polyethylenedioxythiophene.2-acrylamide-methylpropanesulfonic acid, polyaniline.polystyrenesulfonic acid, polyaniline.polyisoprenesulfonic acid, polyaniline.2-acrylamide-methylpropanesulfonic acid, polypyrrole.polystyrenesulfonic acid, polypyrrole.polyisoprenesulfonic acid, polypyrrole.2-acrylamide-methylpropanesulfonic acid and copolymers containing such a component.

Of these, polyethylenedioxythiophene.polystyrenesulfonic acid (PEDOT.PSS), polyethylenedioxythiophene.polyisoprenesulfonic acid, polyaniline.2-acrylamide-methylpropanesulfonic acid and copolymers containing such a component are preferable.

### (Hydrophobilization Treatment of Conductive Polymer Composition)

In the invention, it is essential to subject the conductive polymer composition to a hydrophobilization treatment from the standpoints of enhancing the solubility of the conductive polymer composition in an organic solvent, enhancing the affinity with the polyfunctional fluorine-containing monomer and the like. Examples of the hydrophobilization treatment include a treatment of modifying the anion group of the polyanion dopant to achieve the hydrophobilization.

As a method for performing the hydrophobilization, examples of a first method include methods in which the anion group is subjected to esterification, etherification, acetylation, tosylation, tritylation, alkylsilylation or alkylcarbonylation. Of these, esterification and etherification are preferable. Examples of a method for achieving the hydrophobilization by esterification include a method in which the anion group of the polyaniline dopant is chlorinated with a chlorinating agent, followed by esterification with an alcohol such as methanol and ethanol. Also, the hydrophobilization can be achieved through esterification with a sulfo group or a carboxyl group using a compound having a hydroxyl group or a glycidyl group and also having an unsaturated double bonding group.

In the invention, various methods which have been conventionally known can be adopted. An example thereof is specifically disclosed in JP-A-2005-314671, JP-A-2006-28439 and the like.

Examples of a second method for performing the hydrophobilization include a method in which a basic compound is bonded to the anion group of the polyanion dopant, thereby achieving the hydrophobilization. As the basic compound, an amine based compound is preferable, and examples thereof include primary amines, secondary amines, tertiary amines and aromatic amines. Specific examples thereof include primary, secondary or tertiary amines substituted with an alkyl group having from 1 to 20 carbon atoms; an imidazole substituted with an alkyl group having from 1 to 20 carbon atoms; and pyridine. For the purpose of enhancing the solubility in an organic solvent, a molecular weight of the amine is preferably from 50 to 2,000, more preferably from 70 to 1,000, and most preferably from 80 to 500.

An amount of the amine compound which is a basic hydrophobilizing agent is preferably from 0.1 to 10.0 molar equivalents, more preferably from 0.5 to 2.0 molar equivalents, and especially preferably from 0.85 to 1.25 molar equivalents to the anion group of the polyanion dopant which does not contribute to doping of the π-conjugated system conductive polymer. So far as the amount of the amine compound falls within the foregoing range, solubility in an organic solvent, conductivity and strength of a coating film can be satisfied.

In the invention, various methods which have been conventionally known can be adopted. An example thereof is specifically disclosed in JP-A-2008-115215, JP-A-2008-115216 and the like.

(Organic Solvent Having a Relative Dielectric Constant of from 2 to 30)

In the invention, in order to prepare the composition for low refractive index layer containing a polyfunctional fluorine-containing monomer and a conductive polymer composition, it is preferable that the conductive polymer composition can be dispersed with an organic solvent having a relative dielectric constant of from 2 to 30 and a water content of not more than 5% by mass.

As such an organic solvent, for example, an alcohol, an aromatic hydrocarbon, an ether, a ketone, an ester and the like are suitable. Compounds are exemplified below, and a relative dielectric constant is expressed in each of the parentheses.

Examples of the alcohol include a monohydric alcohol and a dihydric alcohol, and of these, the monohydric alcohol is preferably a saturated aliphatic alcohol having from 2 to 8 carbon atoms. Specific examples of such an alcohol include ethyl alcohol (25.7), n-propyl alcohol (21.8), isopropyl alcohol (18.6), n-butyl alcohol (17.1), sec-butyl alcohol (15.5) and tert-butyl alcohol (11.4). Also, specific examples of the aromatic hydrocarbon include benzene (2.3), toluene (2.2) and xylene (2.2); specific examples of the ether include tetrahydrofuran (7.5), ethylene glycol monomethyl ether (16), ethylene glycol monomethyl ether acetate (8), ethylene glycol monoethyl ether (14), ethylene glycol monoethyl ether acetate (8) and ethylene glycol monobutyl ether (9); specific examples of the ketone include acetone (21.5), diethyl ketone (17.0), methyl ethyl ketone (15.5), diacetone alcohol (18.2), methyl isobutyl ketone (13.1) and cyclohexanone (18.3); and specific examples of the ester include methyl acetate (7.0), ethyl acetate (6.0), propyl acetate (5.7) and butyl acetate (5.0).

From the viewpoint of the fact that both the conductive polymer composition and the polyfunctional fluorine-containing monomer can be dissolved and dispersed, the relative dielectric constant of the organic solvent is more preferably from 2.3 to 24, further preferably from 4.0 to 21, and especially preferably from 5.0 to 21. For example, isopropyl alcohol, acetone, propylene glycol monoethyl ether, methyl ethyl ketone, cyclohexane and methyl acetate are preferable, with isopropyl alcohol, acetone, methyl ethyl ketone and propylene glycol monoethyl ether being especially preferable.

The organic solvent having a relative dielectric constant of from 2 to 30 can also be used in admixture of two or more kinds thereof. Also, though an organic solvent having a relative dielectric constant exceeding 30 or water (an amount of which is, however, not more than 5% by mass of the whole) can be used jointly, it is preferable that a relative dielectric constant of the mixed solvent (a mass average relative dielectric constant of the organic solvent and water to be contained) is from 2 to 30. By making the relative dielectric constant fall within the foregoing range, a coating solution having both the conductive polymer composition and the polyfunctional fluorine-containing monomer dissolved and dispersed therein can be formed, and an antireflection film having favorable surface properties of the coating film can be formed.

### (Solubilization Aid)

A solubilization aid may be contained in the conductive polymer composition.

By using the solubilization aid, the solubilization of the π-conjugated system conductive polymer in an organic solvent having a low water content can be aided, and furthermore, the coating surface properties of the composition for low refractive index layer can be improved, or the strength of the cured film can be increased.

The solubilization aid is preferably a copolymer having a hydrophilic site, a hydrophobic site and an ionizing radiation curable functional group-containing site, and especially preferably a block type or graft type copolymer in which these sites are separated into segments. Such a copolymer can be subjected to living anion polymerization or living radical polymerization, or can be polymerizing using a macromonomer having the foregoing sites.

The solubilization aid is disclosed in, for example, [0022] to [0038] of JP-A-2006-176681 or the like.

In the solubilization aid, in the case of a copolymer, a proportion of structural units in the hydrophilic segment and the hydrophobic segment is preferably from 1/99 to 60/40, and more preferably from 2/98 to 30/70 in terms of a mass ratio. A use amount of the solubilization aid is preferably from 1 to 100% by mass, more preferably from 2 to 70% by mass, and most preferably from 5 to 50% by mass relative to the total sum of the π-conjugated system conductive polymer and the polyanion dopant.

### (Low Molecular Weight Dopant)

In the invention, it is also preferably to jointly use a low molecular weight dopant in addition to the polyanion dopant. As the low molecular weight dopant, a compound having not more than 2 anion groups in one molecule and having a molecular weight of not more than 1,000 is preferable. Above all, it is preferable that at least one member of compounds selected from the group consisting of 2-acrylamide-2-methyl-1-propanesulfonic acid, 1,1-oxybistetrapropylene derivatives, sodium benzenesulfonate and vinyl allyl sulfonate.

### (Preparation Method of Conductive Polymer Composition)

The conductive polymer composition in the invention is preferably one in which the π-conjugated system conductive polymer and the polyanion dopant are dissolved or dispersed in an organic solvent. Here, it is preferable that the water content of the organic solvent is not more than 5% by mass.

As a method for preparing such a conductive polymer composition, though there are various methods, the following three methods are preferable.

A first method is a method in which the monomer is polymerized in water in the copresence of the polyanion dopant to form the π-conjugated system conductive polymer; if desired, the π-conjugated system conductive polymer is then treated by the addition of the foregoing solubilization aid or basic hydrophobilizing agent; and thereafter, water is displaced with the organic solvent.

A second method is a method in which the monomer is polymerized in water in the copresence of the polyanion dopant to form the π-conjugated system conductive polymer; if desired, the π-conjugated system conductive polymer is then treated by the addition of the foregoing solubilization aid or basic hydrophobilizing agent; and after water is evaporated to dryness, the organic solvent is added to achieve the solubilization.

A third method is a method in which after the π-conjugated system conductive polymer and the polyanion dopant are separately prepared, the both are mixed and dispersed in a solvent to prepare a conductive polymer composition in a doped state, and in the case where water is contained in the solvent, the water is displaced with an organic solvent.

In the foregoing methods, a use amount of the solubilization aid is preferably from 1 to 100% by mass, more preferably from 2 to 70% by mass, and most preferably from 5 to 50% by mass relative to the total sum of the π-conjugated system conductive polymer and the polyanion dopant.

Also, in the first method, a method for displacing water with the organic solvent is preferably a method in which after a solvent with high water miscibility, such as ethanol, isopropyl alcohol and acetone, is added to form a uniform solution, ultrafiltration is performed to remove water. Also, there is exemplified a method in which after the water content is lowered to some extent by using a solvent with high water miscibility, a more hydrophobic solvent is mixed, and a highly volatile component is removed under reduced pressure to regulate the solvent composition. Also, when sufficient hydrophobilization is performed using the basic hydrophobilizing agent, an organic solvent with low water miscibility is added to form a separated two-phase system, thereby making it possible to extract the π-conjugated system conductive polymer in an aqueous phase into an organic solvent phase.

As to the hydrophobilized conductive polymer composition containing the π-conjugated system conductive polymer and the anion group-containing polymer dopant according to the invention, examples of a commercially available product include SEPLEGYDA SAS-PD (manufactured by Shin-Etsu Polymer Co., Ltd.) and ELCOAT UVH515 (manufactured by Idemitsu Technofine Co., Ltd.).

### (Organic Solvent)

The organic solvent which is used in the composition for low refractive index layer in the invention can be selected from the viewpoints such that each component can be dissolved or dispersed therein; that uniform surface properties are easily obtained in a coating step and a drying step; that liquid preservability can be ensured; and that it has a proper saturated vapor pressure. The organic solvent can be used in admixture of two or more kinds thereof. It is preferable from the viewpoint of solubility or dispersibility that a relative dielectric constant of the organic solvent is from 2 to 30. Also, it is preferable from the viewpoint of a drying load that a solvent having a boiling point of not higher than 100° C. at room temperature under atmospheric pressure is used as the major component, whereas a small amount of a solvent having a boiling point exceeding 100° C. is contained for the purpose of regulating the drying speed.

Examples of the solvent having a boiling point of not higher than 100° C. include hydrocarbons such as hexane (boiling point: 68.7° C.), heptane (boiling point: 98.4° C.), cyclohexane (boiling point: 80.7° C.) and benzene (boiling point: 80.1° C.); halogenated hydrocarbons such as dichloromethane (boiling point: 39.8° C.), chloroform (boiling point: 61.2° C.), carbon tetrachloride (boiling point: 76.8° C.), 1,2-dichloroethane (boiling point: 83.5° C.) and trichloroethylene (boiling point: 87.2° C.); ethers such as diethyl ether (boiling point: 34.6° C.), diisopropyl ether (boiling point: 68.5° C.), dipropyl ether (boiling point: 90.5° C.) and tetrahydrofuran (boiling point: 66° C.); esters such as ethyl formate (boiling point: 54.2° C.), methyl acetate (boiling point: 57.8° C.), ethyl acetate (boiling point: 77.1° C.) and isopropyl acetate (boiling point: 89° C.); ketones such as acetone (boiling point: 56.1° C.) and 2-butanone (the same as methyl ethyl ketone (MEK), boiling point: 79.6° C.); alcohols such as methanol (boiling point: 64.5° C.), ethanol (boiling point: 78.3° C.), 2-propnaol (boiling point: 82.4° C.) and 1-propanol (boiling point: 97.2° C.); cyano compounds such as acetonitrile (boiling point: 81.6° C.) and propionitrile (boiling point: 97.4° C.); and carbon disulfide (boiling point: 46.2° C.). Of these, ketones and esters are preferable; and ketones are especially preferable. Among the ketones, 2-butanol is especially preferable.

Examples of the solvent having a boiling point exceeding 100° C. include octane (boiling point: 125.7° C.), toluene (boiling point: 110.6° C.), xylene (boiling point: 138° C.), tetrachloroethylene (boiling point: 121.2° C.), chlorobenzene (boiling point: 131.7° C.), dioxane (boiling point: 101.3° C.), dibutyl ether (boiling point: 142.4° C.), isobutyl acetate (boiling point: 118° C.), cyclohexanone (boiling point: 155.7° C.), 2-methyl-4-pentanone (the same as MIBK, boiling point: 115.9° C.), 1-butanol (boiling point: 117.7° C.), N,N-dimethylformamide (boiling point: 153° C.), N,N-dimethylacetamide (boiling point: 166° C.) and dimethyl sulfoxide (boiling point: 189° C.). Of these, cyclohexanone and 2-methyl-4-pentanone are preferable.

As another preferred embodiment of using two or more kinds of organic solvents, the use of two kinds of solvents in which a difference in the boiling point is larger than a specified value is exemplified. The difference in the boiling point between the two kinds of solvents is preferably 25° C. or more, especially preferably 35° C. or more, and further preferably 50° C. or more. When the difference in the boiling point is large, the maldistribution in a lower part of the inorganic fine particle and the separation of the binder are easily achieved.

### (Antifouling Agent)

For the purpose of imparting characteristics such as antifouling resistance, water resistance, chemical resistance and slipperiness to the low refractive index layer, the composition for low refractive index layer in the invention may contain an antifouling agent. The antifouling agent is preferably a fluorine-containing antifouling agent or a silicone based antifouling agent. Also, such a compound has an effect for accelerating the maldistribution in a lower part in a film thickness direction of the low refractive index layer of the π-conjugated system conductive polymer composition.

An addition amount of the antifouling agent is preferably in the range of from 0.01 to 20% by mass, more preferably in the range of from 0.05 to 10% by mass, and especially preferably in the range of from 0.1 to 5% by mass relative to the whole of solids of the composition for low refractive index layer.

It is preferable that the fluorine-containing antifouling agent has a polymerizable unsaturated group. According to this, it is possible to suppress the transfer of a fluorine compound onto the back surface and improve the scar resistance at the time of storing a coated material in a rolled state and also to enhance the durability against repeated wiping-off of a foul.

Preferred embodiments, specific examples and the like of the fluorine-containing antifouling agent are disclosed in paragraphs [0218] and [0219] of JP-A-2007-301970, and the same can also be applied in the invention.

The silicone based antifouling agent is able to add for the purposes of enhancing the scar resistance due to impartation of slipperiness and imparting antifouling properties, and a compound having a polysiloxane structure is preferable. Preferred embodiments, specific examples and the like of the silicone based antifouling agent are disclosed in paragraphs [0212] to [0217] of JP-A-2007-301970, and the same can also be applied in the invention.

For the purpose of imparting characteristics such as dustproof properties and antistatic properties, dustproof agents or antistatic agents such as known cationic surfactants and polyoxyalkylene based compounds can also be properly added. With respect to such a dustproof agent or antistatic agent, its structural unit may be contained as a part of the function in the foregoing fluorine based compound or silicone based compound. When such a dustproof agent or antistatic agent is added as an additive, it is preferably added in an amount ranging from 0.01 to 20% by weight, more preferably from 0.05 to 10% by weight, and especially preferably from 0.1 to 5% by weight of the whole of solids of the low refractive index layer. Examples of preferred compounds include MEGAFAC F-150 (a trade name), manufactured by DIC Corporation and SH-3748 (a trade name), manufactured by Dow Corning Toray Co., Ltd. However, it should not be construed that the invention is limited thereto.

### (Fluorine-Containing Polymer)

From the standpoint of enhancing the stability in surface properties at the time of coating and drying, it is preferable that the composition for low refractive index layer in the invention contains a fluorine-containing polymer.

The fluorine-containing polymer may be a polymer of a fluorine-containing monomer or a copolymer of a fluorine-containing monomer and a non-fluorine-containing monomer. Examples of the fluorine-containing monomer include a fluorine-containing vinyl monomer, a fluorine-containing (meth)acrylic monomer and a fluorine-containing glycidyl monomer. Of these, a fluorine-containing vinyl monomer is preferable for the reasons of easiness of availability of a raw material and easiness of control of the polymerization. Examples of the fluorine-containing vinyl monomer include fluoroolefins (for example, fluoroethylene, vinylidene fluoride, tetrafluoroethylene, hexafluoropropylene, etc.); partially or completely fluorinated alkyl ester derivatives of a (meth)acrylic acid segment (for example, BISCOAT 6FM (a trade name, manufactured by Osaka Organic Chemical Industry Ltd.), R-20202 (a trade name, manufactured by Daikin Industries, Ltd.), etc.); and completely or partially fluorinated vinyl ethers. Of these, perfluoroolefins are preferable; and hexafluoropropylene is especially preferable from the viewpoints of refractive index, solubility, transparency, availability and the like. By increasing a composition ratio of such a fluorine-containing vinyl monomer, though the refractive index can be decreased, the film strength is lowered. In the invention, the fluorine-containing vinyl monomer is introduced such that a fluorine content of the copolymer is preferably from 20 to 60% by mass, more preferably from 25 to 55% by mass, and especially preferably from 30 to 50% by mass.

The fluorine-containing copolymer and its preferred embodiment according to the invention are disclosed in paragraphs [0081] to [0089] of JP-A-2009-098658, and the same can also be applied in the invention.

A mass average molecular weight of the fluorine-containing polymer is preferably 5,000 or more, more preferably from 10,000 to 500,000, and most preferably from 15,000 to 200,000. Polymers having a different average molecular weight from each other can be used jointly, and according to this, an improvement of the coating film surface properties or an improvement of the scar resistance can also be achieved.

### (Inorganic Fine Particle)

In the invention, from the viewpoints of realizing a low refractive index and improving the scar resistance, it is preferable to use an inorganic fine particle for the low refractive index layer. An average particle size (primary particle size) of the inorganic fine particle is preferably from 5 to 120 nm, more preferably from 10 to 100 nm, further preferably from 20 to 100 nm, and most preferably from 40 to 90 nm. Also, from the viewpoint of realizing a low refractive index, an inorganic low-refractive index particle is preferable.

When the particle size of the inorganic fine particle is too small, an effect for improving the scar resistance becomes small, whereas when it is too large, fine irregularities are formed on the surface of the low refractive index layer, whereby an appearance such as black tightness and an integrated reflectance are deteriorated. The inorganic fine particle may be either crystalline or amorphous. Also, the inorganic fine particle may be a monodispersed particle or a coagulated particle so far as it is satisfied with a prescribed particle size. Though a shape of the inorganic fine particle is most preferably spherical, there is no problem even when it is amorphous.

As the inorganic fine particle, fine particles of magnesium fluoride or silica are preferably exemplified because of a low refractive index. Of these, a silica fine particle is especially preferable from the standpoints of refractive index, dispersion stability and costs.

An application amount of the inorganic fine particle is preferably from 1 mg/m² to 100 mg/m², more preferably from 5 mg/m² to 80 mg/m², and further preferably from 10 mg/m² to 60 mg/m². When the application amount of the inorganic fine particle is too small, the effect for improving the scar resistance is reduced, whereas when it is too large, fine irregularities are formed on the surface of the low refractive index layer, whereby an appearance such as black tightness and an integrated reflectance are deteriorated.

### (Fine Particle Having Pores in the Inside Thereof)

In order to contrive to realize a low refractive index, it is preferable to use a fine particle having pores in the inside thereof, and it is more preferable to use a fine particle having a porous or hollow structure. It is especially preferable to use a silica particle having a hollow structure. A porosity of such a fine particle is preferably from 10 to 80%, more preferably from 20 to 60%, and most preferably from 30 to 60%. What the porosity of the hollow fine particle is made to fall within the foregoing range is preferable from the viewpoints of realizing a low refractive index and keeping durability of the particle.

In the case where the porous or hollow fine particle is silica, a refractive index of the fine particle is preferably from 1.10 to 1.40, more preferably from 1.15 to 1.35, and most preferably from 1.15 to 1.30. Here, the refractive index expresses a refractive index as the whole of the particle but does not express a refractive index of only silica as a shell which forms the silica particle.

An application amount of the porous or hollow silica is preferably from 1 mg/m² to 100 mg/m², more preferably from 5 mg/m² to 80 mg/m², and further preferably from 10 mg/m² to 60 mg/m². When the application amount of the porous or hollow silica is too small, the effect for realizing a low refractive index or the effect for improving the scar resistance is reduced, whereas when it is too large, fine irregularities are formed on the surface of the low refractive index layer, whereby an appearance such as black tightness and an integrated reflectance are deteriorated.

When the particle size of the silica fine particle is too small, a proportion of the cavity part is reduced, and a lowering of the refractive index cannot be expected; whereas when it is too large, fine irregularities are formed on the surface of the low refractive index layer, whereby an appearance such as black tightness and an integrated reflectance are deteriorated. The silica fine particle may be either crystalline or amorphous and is preferably a monodispersed particle. Though a shape of the silica fine particle is most preferably spherical, it may be amorphous.

Also, as to hollow silica, two or more kinds of fine particles having a different average particle size from each other can be used jointly. Here, the average particle size of hollow silica can be determined from an electron microscopic photograph.

In the invention, the hollow silica has a specific surface area of preferably from 20 to 300 m²/g, more preferably from 30 to 120 m²/g, and most preferably 40 to 90 m²/g.

The surface area can be determined by a BET method using nitrogen.

In the invention, it is possible to use a pore-free silica particle together with the hollow silica. The pore-free silica has a particle size of preferably 30 nm or more and not more than 150 nm, more preferably 35 nm or more and not more than 100 nm, and most preferably 40 nm or more and not more than 80 nm.

Preferred embodiments, preparation methods and surface treatment method s of the inorganic fine particle and porous or hollow fine particle according to the invention and an organosilane compound and a metal chelate compound used for the surface treatment or the like are disclosed in paragraphs [0033] to [0078] of JP-A-2009-098658, and the same can also be applied in the invention.

### (Polymerization Initiator)

It is preferable that a polymerization initiator is contained in the composition for low refractive index layer in the invention. Though various materials can be used as the polymerization initiator, a photopolymerization initiator is preferable. Examples of the photopolymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borate salts, active esters, active halogens, inorganic complexes and coumarins.

Specific examples, preferred ranges, preferred embodiments, commercially available products and the like of the photopolymerization initiator are disclosed in paragraphs [0133] to [0151] of JP-A-2009-098658, and the same can also be applied in the invention. Also, other polymerization initiators are disclosed in paragraphs [0232] to [0236] of JP-A-2006-293329.

A use amount of the photopolymerization initiator is preferably in the range of from 0.1 to 15 parts by mass, and more preferably from 1 to 10 parts by mass based on 100 parts by mass of the binder.

In addition to the photopolymerization initiator, a photosensitizer may be used. Specific examples of the photosensitizer include n-butylamine, triethylamine, tri-n-butyl phosphine, Michler's ketone and thioxanthone. Furthermore, at least one auxiliary agent such as azide compounds, thiourea compounds and mercapto compounds may be combined and used.

With respect to commercially available photosensitizers, there are enumerated KAYACURE Series, manufactured by Nippon Kayaku Co., Ltd. (for example, DMBI and EPA).

### (Re: Physical Properties and the Like of Low Refractive Index Layer)

A refractive index of the low refractive index layer in the invention is preferably from 1.20 to 1.47, more preferably from 1.25 to 1.46, and especially preferably from 1.30 to 1.46.

A thickness of the low refractive index layer is preferably from 50 to 200 nm, and more preferably from 70 to 100 nm.

In the invention, by making the conductive compound bottom-maldistributed in a film thickness direction, in the case where the refractive index varies in the film thickness direction within the low refractive index layer, an upper part containing a large amount of the polyfunctional fluorine-containing monomer having a polymerizable group becomes lower in a refractive index than the bottom. Furthermore, in the case where the bottom maldistribution of the conductive polymer within the low refractive index layer is remarkable, the low refractive index layer of the invention can also be dealt as one configured of two layers having an approximately different refractive index from each other. In that case, it is preferable that the refractive index and film thickness of the upper part are satisfied with the foregoing ranges of the refractive index and film thickness.

A haze of the low refractive index layer is preferably not more than 3%, more preferably not more than 2%, and most preferably not more than 1%.

A hardness of the low refractive index layer is preferably H or more, more preferably 2H or more, and most preferably 3H or more by a pencil hardness test with a load of 500 g.

Furthermore, in order to improve an antifouling performance of the antireflection film, a contact angle against water on the surface is preferably 90° or more, more preferably 95° or more, and especially preferably 100° or more.

### (Support)

The support in the antireflection film of the invention is preferably a transparent support, and more preferably a transparent plastic film. Examples of a polymer capable of forming a plastic film include cellulose esters (for example, triacetyl cellulose, diacetyl cellulose, and representatively TAC-TD80U and TAC-TD80UF (all of which are manufactured by Fujifilm Corporation), etc.), polyamides, polycarbonates, polyesters (for example, polyethylene terephthalate, polyethylene naphthalate, etc.), polystyrenes, polyolefins, norbornene based resins (for example, ARTON (a trade name, manufactured by JSR Corporation)) and amorphous polyolefins (for example, ZEONEX (a trade name, manufactured by Zeon Corporation)). Of these, triacetyl cellulose, polyethylene terephthalate and polyethylene naphthalate are preferable; and triacetyl cellulose is especially preferable. Also, a cellulose acylate film which does not substantially contain a halogenated hydrocarbon such as dichloromethane and a manufacturing method thereof are disclosed in Journal of Technical Disclosure No. 2001-1745 (issued on Mar. 15, 2001, by the Japan Institute of Invention and Innovation), and the cellulose acylate disclosed therein can be preferably used in the invention.

### (Antireflection Film)

The antireflection film of the invention has a low refractive index layer provided with an antistatic function on a support. Also, the antireflection film of the invention may has an antireflection layer such as a hard coat layer and a high refractive index layer, if desired. The antireflection layer can be laminated such that the reflectance is reduced by optical interference, while taking into consideration a refractive index, a film thickness, a number of layers, an order of layers and the like. So far as the simplest configuration is concerned, the antireflection film has a configuration in which only the low refractive index layer is provided on the support. Furthermore, for the purpose of lowering the reflectance, it is preferable that the antireflection layer is configured of a combination of a high refractive index layer having a refractive index higher than that of the support and a low refractive index layer having a refractive index lower than that of the support. Examples of the configuration include a two-layer configuration of (high refractive index layer)/(low refractive index layer) from the support side; and a configuration of three layers having a different refractive index from each other and composed of a laminate of (middle refractive index layer (layer having a refractive index higher than that of the support or hard coat layer and lower than the high refractive index layer))/(high refractive index layer)/(low refractive index layer) in this order from the support side. There is also proposed a laminate including more antireflection layers. Above all, from the standpoints of durability, optical characteristics, costs, productivity and the like, it is preferable that a middle refractive index layer, a high refractive index layer and a low refractive index layer are coated in this order on the support having a hard coat layer. Also, an antiglare layer, a second antistatic layer and the like may be provided, if desired.

Examples of the layer configuration of the antireflection film of the invention are given below. The low refractive index layer has an antistatic function

Support/low refractive index layer

Support/middle refractive index layer/low refractive index layer

Support/middle refractive index layer/high refractive index layer/low refractive index layer

Support/hard coat layer/low refractive index layer

Support/hard coat layer/high refractive index layer/low refractive index layer

Support/hard coat layer/middle refractive index layer/high refractive index layer/low refractive index layer

Support/antiglare layer/low refractive index layer

Support/antiglare layer/high refractive index layer/low refractive index layer

Support/antiglare layer/middle refractive index layer/high refractive index layer/low refractive index layer

Support/hard coat layer/antiglare layer/low refractive index layer

Support/hard coat layer/antiglare layer/high refractive index layer/low refractive index layer

Support/hard coat layer/antiglare layer/middle refractive index layer/high refractive index layer/low refractive index layer

Support/second antistatic layer/low refractive index layer

Support/antiglare layer/second antistatic layer/low refractive index layer

Support/hard coat layer/antiglare layer/second antistatic layer/low refractive index layer

Support/hard coat layer/second antistatic layer/glare layer/low refractive index layer

Support/hard coat layer/second antistatic layer/high refractive index layer/low refractive index layer

Support/second antistatic layer/hard coat layer/middle refractive index layer/high refractive index layer/low refractive index layer

Second antistatic layer/support/hard coat layer layer/middle refractive index layer/high refractive index layer/low refractive index layer

Support/second antistatic layer/antiglare layer/middle refractive index/high refractive index layer/low refractive index layer

Second antistatic layer/support/antiglare layer/middle refractive index layer/high refractive index layer/low refractive index layer

Second antistatic layer/support/antiglare layer/high refractive index layer/low refractive index layer/high refractive index layer/low refractive index layer

### (Performance of Antireflection Film, and the Like)

A haze value of the antireflection film of the invention is preferably from 3 to 70%, and more preferably from 4 to 60%.

An average reflectance at from 450 nm to 650 nm of the antireflection film of the invention is preferably not more than 3.0%, and more preferably not more than 2.5%. So far as the antireflection film of the invention has the foregoing ranges of haze value and average reflectance, when used for an image display device, favorable antiglare properties and antireflection properties are obtainable without being accompanied with deterioration of a transmitted image.

A common logarithm log(SR) of a surface resistivity SR (Ω/sq) of the antireflection film of the invention is not more than 13.0. The log(SR) is more preferably not more than 11.0, and further preferably not more than 9.0. In the invention, by making the refractive index of the low refractive index layer fall within the foregoing range and making the surface resistivity of the antireflection film fall within the foregoing range, the dustproof properties and low reflectance can be kept good. When the low (SR) is larger than 13.0, the dustproof properties are worse.

Also, in the case of providing an antifouling layer, it can be provided for the uppermost layer of the foregoing configuration.

### (Hard Coat Layer)

For the purpose of imparting a physical strength to the antireflection film, a hard coat layer can be provided as the need arises. The hard coat layer can be provided on the surface of the support. In particular, it is preferable that the hard coat layer is provided between the support and the high refractive index layer (or middle refractive index layer). The hard coat layer can be formed of a binder, an inorganic filler for preventing crosslinking shrinkage and realizing a high strength and a mat particle for the purpose of imparting antiglare properties, if desired, and the like. Also, by containing a high refractive index particle in the hard coat layer, the hard coat layer can also work as the high refractive index layer.

It is preferable that the binder of the hard coat layer is formed by a crosslinking reaction or polymerization reaction of a curable compound. For example, the binder can be formed by coating a coating composition containing a curable polyfunctional monomer or polyfunctional oligomer and subjecting the polyfunctional monomer or polyfunctional oligomer to a crosslinking reaction or polymerization reaction.

The binder, crosslinking agent and initiator and the like are also disclosed in paragraphs [0178] to [0197] of JP-A-2008-26658, and they can also be suitably used in the invention.

Specific examples of the fine inorganic filler which is used for the hard coat layer include TiO₂, ZrO₂, Al₂O₃, In₂O₃, ZnO, SnO₂, Sb₂O₃, ITO and SiO₂. Of these, TiO₂ and ZrO₂ are especially preferable form the standpoint of realizing a high refractive index.

It is also preferable that a surface of the inorganic filler is subjected to a silane coupling treatment or a titanium coupling treatment, and a surface treating agent having a functional group capable of reacting with a species of the binder on the filler surface is preferably used.

An addition amount of such an inorganic filler is preferably from 10 to 90%, more preferably from 20 to 80%, and especially preferably from 30 to 70% of the total mass of the hard coat layer.

Since such a filler has a particle size sufficiently shorter than the wavelength of light, it has such natures that scattering is not generated and that a dispersion having the filler dispersed in a binder polymer acts as an optically uniform substance.

For the purpose of imparting antiglare properties to the hard coat layer, a mat particle which is larger than the inorganic filler particle and which has an average particle size of preferably from 0.1 to 10.0 μm, and more preferably from 1.5 to 8.5 μm can be contained in, for example, a particle of an inorganic compound or a resin particle. From the viewpoints of prevention of cloudiness of the film and a favorable light diffusing effect, a difference in a refractive index between the mat particle and the binder is preferably from 0.02 to 0.20, and especially preferably from 0.04 to 0.10. From the same viewpoint as in the refractive index, an addition amount of the mat particle to the binder is preferably from 3 to 30% by mass, and especially from 4 to 20% by mass.

Specific examples of the foregoing mat particle include particles of an inorganic compound such as a silica particle and a TiO₂ particle; and resin particles such as an acrylate particle, a crosslinked acrylate particle, a polystyrene particle, a crosslinked styrene particle, a melamine resin particle and a benzoguanamine resin particle. Of these, a crosslinked styrene particle, a crosslinked acrylate particle and a silica particle are preferable. As to the shape of the mat particle, all of a truly spherical shape and an amorphous shape are useful.

Also, two or more different kinds of mat particles may be used in combinations. In the case of using two or more kinds of mat particles, in order to effectively exhibit the control of the refractive index due to mixing of the both, a difference in the refractive index is preferably 0.02 or more and not more than 0.10, and especially preferably 0.03 or more and not more than 0.07.

Also, it is possible to impart antiglare properties by a mat particle having a larger particle size and to impart other optical characteristics by a mat particle having a smaller particle size, respectively. For example, in the case where an antireflection film is stuck onto a high definition display with 133 ppi or more, it is required that a fault on display image quality which is called “glare” is not caused. The “glare” is derived from the fact that pixels are enlarged or shrunk by irregularities (contributing to the antiglare properties) present on the film surface so that uniformity of luminance is lost. It is possible to greatly improve the glare by using a mat particle having a smaller particle size than the mat particle capable of imparting the antiglare properties and having a different refractive index from the binder together.

With respect to the particle size distribution of the mat particle, a monodispersed particle is the most preferable, and it would be better that the particle size of each particle is identical as far as possible. For example, in the case where a particle having a particle size of at least 20% larger than the average particle size is defined as a coarse particle, a proportion of this coarse particle is preferably not more than 1%, more preferably not more than 0.1%, and further preferably not more than 0.01% of the number of particles. A particle having such particle size distribution is obtained by classification after a usual synthetic reaction. By increasing the number of classification or strengthening its degree, a particle with more preferred distribution can be obtained.

The mat particle is contained in the layer such that the amount of the mat particle in the formed layer is preferably of from 10 to 1,000 mg/m², and more preferably from 100 to 700 mg/m².

The particle size distribution of the particle is measured by the Coulter counter method, and the measured distribution is converted into a particle number distribution.

### (High Refractive Index Layer)

For the purposes of increasing the refractive index of the layer and reducing curing shrinkage, it is preferable that an inorganic filler made of an oxide of at least one metal selected among titanium, zirconium, aluminum, indium, zinc, tin and antimony and having an average particle size of preferably not more than 0.2 μm, more preferably not more than 0.1 μm, and further preferably not more than 0.06 μm is contained in the high refractive index layer.

Also, similar to the foregoing hard coat layer, in the high refractive index layer, a mat particle and an inorganic filler can be used within the same ranges as in the hard coat layer.

Also, for the purpose of making a difference in the refractive index from the mat particle, in the high refractive index layer using a high refractive index mat particle, in order to keep the refractive index of the layer low, it is also preferable to use an oxide of silicon. A preferred particle size is identical with that of the foregoing inorganic fine particle to be used for the low refractive index layer.

A refractive index of a bulk of a mixture of the binder and the inorganic filler in the high refractive index layer of the invention is preferably from 1.48 to 2.00, and more preferably from 1.50 to 1.80. In order that the refractive index may fall within the foregoing range, the kind and amount proportion of the binder and the inorganic filler may be properly selected. How to select can be easily experimentally known in advance.

The high refractive index layer is disclosed in paragraphs [0197] to [0206] of JP-A-2009-98658.

### (Antiglare Layer)

The antiglare layer is disclosed in paragraphs [0178] to [0189] of JP-A-2009-98658, and the same can also be applied in the invention.

### (Surface Property Improving Agent)

In the invention, in order to improve defective surface properties (for example, coating unevenness, drying unevenness, point defect, etc.), a surface property improving agent may be contained in the coating solution to be used for preparing any one of the layers on the support. As the surface property improving agent, at least one of a fluorine based surface property improving agent and a silicone based improving agent is preferable.

The surface property improving agent is disclosed in paragraphs [0258] to [0285] of JP-A-2009-98658, and the same can also be applied in the invention.

In the case where the antireflection film of the invention is used for a liquid crystal display device, it is usually disposed on the outermost surface of a display by, for example, providing an adhesive layer on one surface thereof. In the case where the support is made of, for example, triacetyl cellulose, since triacetyl cellulose can be used as a protective film for protecting a polarizing film of a polarizing plate, from the standpoint of costs, it is preferable that the antireflection film of the invention is used as a protective film as it is.

As described previously, in the case where the antireflection film of the invention is disposed on the outermost surface of a display or is used as a protective film for polarizing plate as it is, for the purpose of improving the adhesion, it is preferable to carry out a saponification treatment after forming a low refractive index layer on the support. The saponification treatment is disclosed in paragraphs [0289] to [0293] of JP-A-2006-293329, and the same can also be applied in the invention.

### (Manufacturing Method of Antireflection Film)

The antireflection film of the invention can be manufactured by coating a coating solution composed of a composition for forming each layer on a support and then drying and curing it. However, it should not be construed that the invention is limited thereto.

First of all, a coating solution containing components for forming each layer is prepared. The resulting coating solution is coated on a support by a dip coating method, an air knife coating method, a curtain coating method, a roller coating method, a wire bar coating method, a gravure coating method, an extrusion coating method or the like and then heated and dried. Of these coating modes, a gravure coating method is preferable because a coating solution of a small coating amount can be coated with high uniformity of the film thickness. In the gravure coating method, a micro gravure method is more preferable because the uniformity of the film thickness is high.

Also, even by adopting a die coating method, a coating solution of a small coating amount can be coated with high uniformity of the film thickness, and furthermore, the die coating method is of a pre-metering mode. Thus, this method is relatively easy in controlling the film thickness and small in transpiration of the solvent in a coating part. Therefore, the die coating method is also preferable.

Two or more layers may be coated simultaneously. A method of the simultaneous coating is disclosed in U.S. Pat. Nos. 2,761,791, 2,941,898, 3,508,947 and 3,526,528 and described in HARASAKI, Yuji, Coating Engineering, page 253, Asakura Shoten (1973).

### (Curing Condition of Antistatic Layer)

Preferred examples of a curing method of the low refractive index layer in the invention are described below.

In the invention, it is contrived to enhance the strength of the coating film by using the polyfunctional fluorine-containing monomer for the low refractive index layer, and after the coating film is formed, it is effective to perform curing through a combination of irradiation with an ionizing radiation with a thermal treatment before the irradiation, simultaneously with the irradiation, or after the irradiation.

Some patterns of a manufacturing process are hereunder described, but it should not be construed that the invention is limited thereto.

Besides the following, a step of performing the thermal treatment simultaneously with the curing with an ionizing radiation is also preferable.

TABLE 1

| | Before irradiation | | Irradiation | | After irradiation |
|---|---|---|---|---|---|
| (1) | Thermal treatment | → | Curing with ionizing radiation | → | — |
| (2) | Thermal treatment | → | Curing with ionizing radiation | → | Thermal treatment |
| (3) | — | → | Curing with ionizing radiation | → | Thermal treatment |

(The term “—” expresses that the thermal treatment is not performed.)

### (Thermal Treatment)

In the invention, as described previously, it is also preferable to perform the thermal treatment in combination with the irradiation with an ionizing radiation. Though the thermal treatment is not particularly limited so far as the constituent layers including the support and the low refractive index layer of the antireflection film are not impaired, a temperature of the thermal treatment is preferably from 60 to 200° C., more preferably from 80 to 130° C., and most preferably from 80 to 110° C. Though a time required for the thermal treatment varies depending upon a molecular weight of each of the components to be used, an interaction with other component, a viscosity and the like, it is from 30 seconds to 24 hours, preferably from 60 seconds to 5 hours, and most preferably from 3 minutes to 30 minutes.

(Irradiation with Ionizing Radiation)

Though a kind of the ionizing radiation is not particularly limited, examples thereof include X-rays, electron beams, ultraviolet rays, visible light and infrared rays. Of these, ultraviolet rays are broadly used. For example, so far as the coating film is ultraviolet curable, it is preferable to cure the low refractive index layer upon irradiation with ultraviolet rays at an irradiation dose of from 10 mJ/cm² to 1,000 mJ/cm² from an ultraviolet lamp. In performing the irradiation, the foregoing energy may be irradiated at once, or may be irradiated dividedly. In particular, from the standpoint of making scattering in performance within the plane of the coating film small, it is preferable to irradiate the energy in a divided manner of from about 2 to 8 times. Also, in the case of forming other layer than the low refractive index layer, the irradiation may be performed for every layer, or after the lamination, the irradiation may be performed on plural layers.

The thermal treatment and the irradiation with an ionizing radiation are disclosed in paragraphs [0148] to [0155] of JP-A-2008-242314, and the same can also be applied in the invention.

### (Polarizing Plate)

The polarizing plate is mainly constituted of two protective films for interposing a polarizing film from the both sides. It is preferable that the antireflection film of the invention is used for at least one of the two protective films for interposing the polarizing film from the both sides. In view of the fact that the antireflection film of the invention also works as the protective film, the manufacturing costs of the polarizing plate can be reduced. Also, by using the antireflection film of the invention for the outmost surface layer, a polarizing plate which prevents reflection of external light and the like and which is excellent in scar resistance, antifouling properties and the like can be formed. Known polarizing films can be used as the polarizing film. The polarizing film is disclosed in paragraphs [0299] to [0301] of JP-A-2006-293329, and the same can also be applied in the invention.

### (Image Display Device)

The antireflection film of the invention can be used for preventing a lowering of the contrast due to reflection of external light or reflection of an image in various image display devices such as a liquid crystal display device (LCD), a plasma display panel (PDP), an electroluminescent display device (ELD), a cathode ray tube display device (CRT), a field emission display (FED) and a surface-conduction electron-emitter display (SED). The antireflection film of the invention or the polarizing plate including the antireflection film is preferably disposed on the surface of a display of the liquid crystal display device (viewing side of the display screen).

In the case where the antireflection film of the invention is used as one side of a surface protective film of a polarizing film, it can be preferably used for transmission type, reflection type or semi-transmission type liquid crystal display devices of a twisted nematic (TN) mode, a super twisted nematic (STN) mode, a vertical alignment (VA) mode, an in-plane switching (IPS) mode, an optically compensatory bend cell (OCB) mode, an electrically controlled birefringence (ECB) mode, etc. The liquid crystal display device is disclosed in paragraphs [0303] to [0307] of JP-A-2006-293329.

### EXAMPLES

The invention is hereunder described in detail with reference to the following Examples, but it should not be construed that the invention is limited thereto. All “part” and “%” are based on a mass basis unless otherwise indicated.

### [Preparation of Composition for Hard Coat Layer)

Respective components were mixed in a composition shown in the following Table 2, and the mixture was filtered through a polypropylene-made filter having a pore size of 30 μm, thereby preparing each of coating solutions HC-1 and HC-2 as a composition for hard coat layer.

TABLE 2

| | Coating solution HC-1 | Coating solution HC-2 |
|---|---|---|
| Binder | PET-30: 22.9 parts by mass | DPCA-20: 40.5 parts by mass |
| | BISCOAT 360: 22.9 parts by mass | |
| Polymerization | IRGACURE 127: 1.5 parts by mass | IRGACURE 184: 2.7 parts by mass |
| initiator | | |
| Light diffusible | 30% MIBK dispersion of 8 μm- | — |
| particle | crosslinked acrylate-styrene | |
| | particle: 8.4 parts by mass | |
| Solvent | MIBK: 19.2 parts by mass | MEK: 48.6 parts by mass |
| | MEK: 25 parts by mass | Cyclohexanone: 5.4 parts by mass |
| Others | — | Silica sol: 2.7 parts by mass |
| Leveling agent | FP-13: 0.1 parts by mass | FP-13: 0.1 parts by mass |

The respective compounds which were used are as follows.

PET-30: Mixture of pentaerythritol triacrylate and pentaerythritol tetraacrylate [manufactured by Nippon Kayaku Co., Ltd.]

BISCOAT 360: Trimethylolpropane PO-added triacrylate [manufactured by Osaka Organic Chemical Industry Ltd.]

DPCA-20: Partial caprolactone-modified polyfunctional acrylate [manufactured by Nippon Kayaku Co., Ltd.]

Silica sol: MIBK-ST [solids concentration: 30% by mass, manufactured by Nissan Chemical Industries, Ltd.]

8 μm-crosslinked acrylate-styrene particle (30% by mass): MIBK dispersion of a particle having an average particle size of 8.0 μm [manufactured by Sekisui Chemical Co., Ltd.], which was prepared by dispersion by a Polytron disperser at 10,000 rpm for 20 minutes

IRGACURE 127: Polymerization initiator [manufactured by Ciba Specialty Chemicals]

IRGACURE 184: Polymerization initiator [manufactured by Ciba Specialty Chemicals]

FP-13: Fluorine based surfactant (used after being dissolved as a 10% by mass solution of MEK)

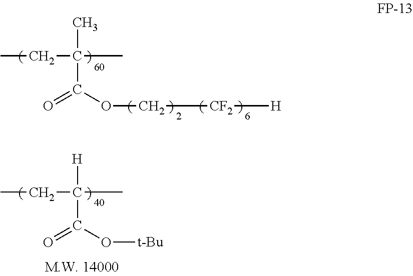

### [Preparation of Composition for Low Refractive Index Layer]

### (Preparation of Conductive Polymer Composition)

### Preparation Example 1

8.0 g of 3,4-ethylenedioxythiophene was added to 1,000 mL of a 2% by mass aqueous solution of polystyrenesulfonic acid (molecular weight: about 100,000) (PS-5, manufactured by Tosoh Organic Chemical Co., Ltd.) and mixed at 20° C. After 100 mL of an oxidation catalyst liquid (containing 15% by mass of ammonium persulfate and 4.0% by mass of ferric sulfate) was added to this mixed liquid, the mixture was allowed to react while stirring at 20° C. for 3 hours.

After 1,000 mL of ion-exchanged water was added to the resulting reaction liquid, about 1,000 mL of the solution was removed by adopting an ultrafiltration method. This operation was repeated thrice.

100 mL of a sulfuric acid aqueous solution (10% by mass) and 1,000 mL of ion-exchanged water were added to the resulting solution, and about 1,000 mL of the solution was removed by adopting an ultrafiltration method.

After 1,000 mL of ion-exchange water was added to the resulting liquid, about 1,000 mL of the liquid was removed by adopting an ultrafiltration method. This operation was repeated five times.

There was thus obtained an about 1.1% by mass aqueous solution. A solids concentration was regulated with ion-exchanged water to form a 1.0% by mass (at 20° C.) aqueous solution. There was thus prepared a conductive polymer composition (B-1). This (B-1) is an aqueous solution, and a relative dielectric constant of water is 80.

The relative dielectric constant was measured at a measuring temperature of 20° C. and a measuring frequency of 10 kHz using a relative dielectric constant measurement device: TRS-10T Model, manufactured by Ando Electric Co., Ltd. by a transformer bridge method.

### Preparation Example 2

After 200 mL of acetone was added to 200 mL of the conductive polymer composition (B-1) prepared in Preparation Example 1, 210 mL of water and acetone were removed by ultrafiltration. This operation was repeated once, and a solids concentration was regulated with acetone to form a 1.0% by mass (at 20° C.) water/acetone solution. There was thus prepared a conductive polymer composition (B-2). This solution had a water content of 15% by mass, and the water/acetone mixed solvent had a relative dielectric constant of 30.3.

### Preparation Example 3

After 500 mL of acetone having 2.0 g of trioctylamine dissolved therein was added to 200 mL of the conductive polymer composition (B-2) prepared in Preparation Example 2, the mixture was stirred by a stirrer for 3 hours. 510 mL of water and acetone were removed by ultrafiltration. A solids concentration was regulated with acetone to form a 1.0% by mass (at 20° C.) water/acetone solution. There was thus prepared a conductive polymer composition (B-3). This solution had a water content of 2% by mass, and the water/acetone mixed solvent had a relative dielectric constant of 22.7.

### Preparation Example 4

300 mL of methyl ethyl ketone was added to 200 mL of the conductive polymer composition (B-3) prepared in Preparation Example 3 and mixed, and the mixture was concentrated under reduced pressure at room temperature to an extent that the total amount reached 200 mL. A solids concentration was regulated with methyl ethyl ketone to form a 1.0% by mass (at 20° C.) water/acetone/methyl ethyl ketone solution. There was thus prepared a conductive polymer composition (B-4). This solution had a water content of 0.05% by mass and an acetone residual ratio of not more than 1% by mass. This water/acetone/methyl ethyl ketone mixed solvent had a relative dielectric constant of 15.5.

### Preparation Example 5

After 500 mL of isopropyl alcohol having 0.8 g of tripropylamine dissolved therein was added to 200 mL of the conductive polymer composition (B-2) prepared in Preparation Example 2, the mixture was stirred by a stirrer for 3 hours. 510 mL of water, acetone and isopropyl alcohol were removed by ultrafiltration. A solids concentration was regulated with isopropyl alcohol to form a 1.0% by mass (at 20° C.) water/acetone/isopropyl alcohol solution. There was thus prepared a conductive polymer composition (B-5). This solution had a water content of 1.8% by mass. This water/acetone/isopropyl alcohol solution had a relative dielectric constant of 22.8.

### Preparation Example 6

### Preparation of Polymerizable Monomer Solution of Organic Conductive Polymer

### (Synthesis of Aniline Polymer)

10 parts by mass of aniline was added dropwise to 100 parts by mass of 1.2 moles/liter of a hydrochloric acid aqueous solution while stirring, and the mixture was cooled to 10° C. An aqueous solution prepared by dissolving 28 parts by mass of ammonium persulfate in 28 parts by mass of ion-exchanged water in advance was added dropwise to this solution over 4 hours. After completion of the dropwise addition, this mixed solution was further stirred at 10° C. for 4 hours. A deposited green precipitate was filtered and washed with ion-exchanged water until a color of the filtrate vanished. Furthermore, the thus obtained precipitates were gathered; the gathered precipitate was dispersed in an ammonia aqueous solution; and the dispersion was filtered at 25° C. for 2 hours and washed with ion-exchanged water until a color of the filtrate varnished, followed by drying to obtain an aniline polymer.

### (Preparation of Polyanion Dopant)

25 parts by mass (20% by mole relative to the whole of monomer components) of 2-acrylamide-methylpropanesulfonic acid, 15 parts by mass (15% by mass relative to the whole of monomer components) of a (methoxy polyethylene glycol methyl methacrylate) macromonomer having a methacryloyl group at one terminal thereof (NK ESTER M-230G, manufactured by Shin-Nakamura Chemical Co., Ltd.), 65 parts by mass of styrene (65% by mole relative to the whole of monomer components) and 3 parts by mass of azoisobutyronitrile as a polymerization initiator were dissolved in a mixed aqueous solution of 20 parts by mass of ion-exchanged water and 130 parts by mass of ethyl alcohol as a solvent, thereby preparing a monomer mixture. Subsequently, the thus prepared monomer mixture was charged in a separable flask equipped with a stirring blade, an inert gas inlet tube, a reflux condenser, a thermometer and a dropping funnel and subjected to a polymerization reaction at 75° C. for 4 hours. Subsequently, 1 part by mass of azoisobutyronitrile was added to this solution, and the mixture was subjected to polymerization ripening at 75° C. for 4 hours, followed by cooling to 30° C. There was thus prepared a sulfate group-containing polyanion dopant having 40% of a non-volatile matter content.

### (Doping of Polyanion Dopant on Aniline Polymer)

Subsequently, 5 parts by mass of the foregoing polymer of aniline, 125 parts by mass of the foregoing polyanion dopant and 370 parts by mass of water were charged, respectively, and the respective components were harmonized with each other. The mixture was dispersed in a discharge amount of 0.5 litters/min at a peripheral speed of 10 m/sec for one hour using a “flow-type sand grinder mill (UVM-2)” (manufactured by Aimex Co., Ltd.) with zirconia beans (0.5 mm in diameter). A temperature at the time of dispersion was regulated to 75° C. There was thus obtained an aniline polymer composition having a concentration of 11%.

### (Displacement of Solvent)

Subsequently, after 200 mL of ethyl alcohol to 20 mL of the foregoing aniline polymer composition, 100 mL of water and ethyl alcohol were removed by ultrafiltration. 200 mL of ethyl alcohol was added to 120 mL of the remaining composition, and 100 mL of water and ethyl alcohol were removed by ultrafiltration. This operation was repeated twice. A solids concentration was regulated with ethyl alcohol to form a 1.0% by mass (at 20° C.) water/ethyl alcohol solution. There was thus prepared a conductive polymer composition (B-6). This solution had a water content of 1% by mass, and the mixed solvent had a relative dielectric constant of 26.2.

### Preparation Example 7

### Preparation of Comparative Conductive Polymer Solution

3-Dodecyloxythiophene was electrochemically polymerized in acetonitrile in the copresence of tetraethylammonium tetrafluoroborate according to the procedures in Example 4 of EP-B-0328981, thereby synthesizing a comparative conductive polymer in which a monoanion dopant was incorporated into a polythiophene derivative. This polythiophene derivative was dissolved in a mixed solution of tetrahydrofuran and butyl acetate in a mass ratio of 9/1 such that its amount was 1% by mass (at 20° C.). There was thus prepared a conductive polymer composition (B-7). This mixed solvent had a relative dielectric constant of 7.25.

### (Synthesis of Polyfunctional Fluorine-Containing Monomer)

Compound F-1 described as a specific example of the polyfunctional fluorine-containing monomer was synthesized by the following route.

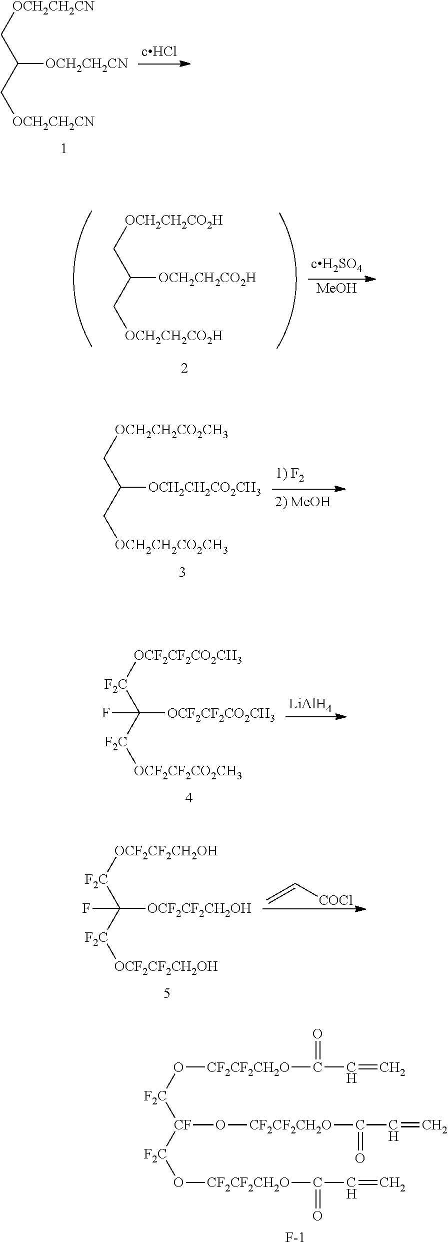

### (Synthesis of Compound 3)

A solution of Compound 1 (36.6 g, 145.6 mmoles) already known in a document [for example, Journal of American Chemical Society, 70, 214 (1948)] and methanol (4 mL) was added dropwise to concentrated hydrochloric acid (110 mL) at 50° C. over one hour. After the reaction solution was stirred at 65° C. for 6 hours, the resulting reaction solution was cooled to 35° C.; methanol (80 mL) was added; and the mixture was further stirred at that temperature for 5 hours. The reaction solution was extracted with toluene (150 mL)/10% salt aqueous solution (100 mL), and an organic layer was concentrated under reduced pressure, thereby obtaining Compound 2. Methanol (40 mL) and concentrated sulfuric acid (1 mL) were added to a concentration residue of Compound 2, and the mixture was stirred at room temperature for 4 hours. After the reaction solution was extracted with toluene (150 mL)/7.5% by mass sodium bicarbonate aqueous solution (150 mL), an organic layer was washed with a 25% by mass salt aqueous solution (150 mL) and dried over sodium sulfate. After the solvent was distilled off under reduced pressure, the residue was purified by column chromatography (developing solvent: ethyl acetate/hexane=1/3), thereby obtaining Compound 3 (40.8 g, 116.5 mmoles, 80%).

### (Synthesis of Compound 4)

A 1-L contained made of TEFLON (registered trademark) equipped with a raw material feed port, a fluorine feed port, a helium gas feed port and an exhaust port connected to a fluorine trap via a reflux device cooled with dry ice was charged with a chlorofluorocarbon solvent (750 mL), and a helium gas was blown at a flow rate of 100 mL/min at an internal temperature of 30° C. for 30 minutes. Subsequently, after a 20% F₂/N₂ gas was blown at a rate of 100 mL/min for 30 minutes, a fluorine flow rate was regulated to 200 mL/min, and 1.1 mL/h of a mixed solution of Compound 3 (15 g, 42.8 mmoles) and hexafluorobenzene (4.0 mL) was added. The fluorine flow rate was decreased to 100 mL/min, hexafluorobenzene (1.2 mL) was added at a rate of 0.6 mL/h, and a 20% F₂/N₂ gas was further allowed to flow at a rate of 100 mL/min for 15 minutes. After the reactor was purged with a helium gas, methanol (100 mL) was added, the mixture was stirred for one hour, and the solvent was then distilled off under reduced pressure. A concentration residue was washed with a diethyl ether/sodium hydrogencarbonate aqueous solution, and an ether layer was dried over magnesium sulfate. After the diethyl ether was distilled off, the residue was subjected to distillation purification at 2 mmHg, thereby obtaining Compound 4 (17.4 g, 26.5 mmoles, 62%).

### (Synthesis of Compound 5)

Lithium aluminum hydride (3.5 g) was dispersed in diethyl ether (300 mL), to which was then added dropwise a diethyl ether (100 mL) solution of Compound 4 (10 g, 15.2 mmoles) at a temperature of not higher than 10° C. The reaction solution was stirred at room temperature for 6 hours, and ethyl acetate (100 mL) was gradually added dropwise thereto. This solution was gradually poured into dilute hydrochloric acid aqueous solution/ice/ethyl acetate, and an insoluble matter was filtered off. An organic layer was washed with water and a salt aqueous solution, and after drying over magnesium sulfate, the resulting organic layer was concentrated under reduced pressure. A residue was purified by column chromatography (developing solvent: ethyl acetate/hexane=1/1), thereby obtaining Compound 5 (8.0 g, 14.0 mmoles, 92%) as a viscous oily material.

### (Synthesis of Compound F-1)

Acrylic acid chloride (2.7 mL) was added dropwise to an acetonitrile (120 mL) solution of Compound 5 (5.7 g, 10 mmoles) and potassium carbonate (9.0 g) at a temperature of not higher than 10° C. After the reaction solution was stirred at room temperature for 5 hours, potassium carbonate (8 g) and acrylic acid chloride (2.5 mL) were supplemented, and the mixture was further stirred for 20 hours. The reaction solution was poured into ethyl acetate (500 mL)/dilute hydrochloric acid aqueous solution (500 mL), followed by liquid separation. After an organic layer was washed with a sodium hydrogencarbonate aqueous solution and a salt aqueous solution, the resulting organic layer was purified by column chromatography (developing solvent: ethyl acetate/hexane=1/3), thereby obtaining Compound F-1 (5.4 g, 74%).

Other polyfunctional fluorine-containing monomers can be synthesized by the same method.

### (Preparation of Inorganic Fine Particle Dispersion)

### (Preparation of Dispersion E-1)

After 20 parts by mass of acryloyloxypropyltrimethoxysilane and 1.5 parts by mass of diisopropoxyaluminum ethyl acetate were added to 500 parts by mass of a silica sol (silica, MEK-ST-L, average particle size: 45 nm, solids concentration: 30% by mass, manufactured by Nissan Chemical Industries, Ltd.) and mixed, 9 parts by mass of ion-exchanged water was added. After the mixture was allowed to react at 60° C. for 8 hours, the reaction mixture was cooled to room temperature, to which was then added 1.8 parts by mass of acetylacetone. Finally, a solids concentration was regulated to 20% by mass, thereby preparing a dispersion E-1.

### (Preparation of Dispersion E-2)

A silica fine particle having a cavity in the inside thereof was prepared by changing the condition at the time of preparation in Preparation Example 4 of JP-A-2002-79616. This was subjected to solvent displacement with methanol from the water dispersion state. Finally, a solids concentration was regulated to 20%, thereby obtaining a particle having an average particle size of 45 nm, a shell thickness of about 7 nm and a refractive index of the silica particle of 1.30. After 15 parts by mass of acryloyloxypropyltrimethoxysilane and 1.5 parts by mass of diisopropoxyaluminum ethyl acetate were added to 500 parts by mass of this dispersion and mixed, 9 parts by mass of ion-exchanged water was added. After the mixture was allowed to react at 60° C. for 8 hours, the reaction mixture was cooled to room temperature, to which was then added 1.8 parts by mass of acetylacetone. Furthermore, the solvent was replaced by distillation under reduced pressure while adding MEK such that the total liquid amount was substantially constant, and finally, a solids concentration was regulated to 20% by mass, thereby preparing a dispersion E-2.

Respective components were mixed as shown in Table 3 to prepare coating solutions Ln-1 to Ln-22 each of which is a composition for low refractive index layer having a solids content of 2.5%. In Ln-15, at a stage of adding the conductive polymer composition (B-1) to form a mixed solution, a coagulate was deposited, and therefore, it was understood that this was not suitable for the preparation of a coating film.

TABLE 3

| | (A) Polyfunctional | | | |
|---|---|---|---|---|
| | fluorine-containing | Non-fluorine-containing | Fluorine-containing | (B) Conductive polymer |
| Coating solution No. | monomer | polyfunctional monomer | copolymer | composition |
| Ln-1 | F-1 (77) | — | — | B-6 (20) |
| Ln-2 | F-1 (77) | — | — | B-4 (20) |
| Ln-3 | F-1 (77) | — | — | B-7 (20) |
| Ln-4 | F-1 (97) | — | — | — |
| Ln-5 | — | DPHA (94) | — | — |
| Ln-6 | — | DPHA (77) | — | B-4 (20) |
| Ln-7 | — | DPHA (57) | — | B-4 (40) |
| Ln-8 | — | DPHA (37) | — | B-4 (60) |
| Ln-9 | F-1 (57) | — | — | B-4 (40) |
| Ln-10 | F-49 (77) | — | — | B-4 (20) |
| Ln-11 | F-35 (74) | — | — | B-4 (20) |
| Ln-12 | F-37 (77) | — | — | B-4 (20) |
| Ln-13 | F-1 (77) | — | — | B-3 (20) |
| Ln-14 | F-1 (77) | — | — | B-5 (20) |
| Ln-15 | F-1 (77) | — | — | B-1 (20) |
| Ln-16 | F-1 (77) | — | — | B-2 (20) |
| Ln-17 | F-49 (50) | DPHA (5) | P-1 (22) | B-4 (20) |
| Ln-18 | F-49 (50) | DPHA (3)/HEAA (2) | P-1 (22) | B-4 (20) |
| Ln-19 | F-49 (50) | DPHA (3)/HEAA (2) | P-1 (17) | B-4 (20) |
| Ln-20 | F-49 (50) | DPHA (3)/HEAA (2) | P-1 (17) | B-4 (20) |
| Ln-21 | F-49 (17) | DPHA (3)/HEAA (2) | P-1 (10) | B-4 (20) |
| Ln-22 | F-49 (17) | DPHA (3)/HEAA (2) | P-1 (10) | B-4 (20) |

| | | | | Diluent | |
|---|---|---|---|---|---|
| | | | Polymerization | | Composition |
| Coating solution No. | Antifouling agent | Fine particle | initiator | Solvent species | ratio |
| Ln-1 | — | — | Irg 127 (3) | MEK/cyclohexanone | 95/5 |
| Ln-2 | — | — | Irg 127 (3) | MEK/cyclohexanone | 95/5 |
| Ln-3 | — | — | Irg 127 (3) | MEK/cyclohexanone | 95/5 |
| Ln-4 | — | — | Irg 127 (3) | MEK/cyclohexanone | 95/5 |
| Ln-5 | — | — | Irg 127 (6) | MEK/cyclohexanone | 95/5 |
| Ln-6 | — | — | Irg 127 (3) | MEK/cyclohexanone | 95/5 |
| Ln-7 | — | — | Irg 127 (3) | MEK/cyclohexanone | 95/5 |
| Ln-8 | — | — | Irg 127 (3) | MEK/cyclohexanone | 95/5 |
| Ln-9 | — | — | Irg 127 (3) | MEK/cyclohexanone | 95/5 |
| Ln-10 | — | — | Irg 127 (3) | MEK/cyclohexanone | 95/5 |
| Ln-11 | — | — | S-1 (6) | MEK/cyclohexanone | 95/5 |
| Ln-12 | — | — | Irg 127 (3) | MEK/cyclohexanone | 95/5 |
| Ln-13 | — | — | Irg 127 (3) | MEK/cyclohexanone | 95/5 |
| Ln-14 | — | — | Irg 127 (3) | MEK/cyclohexanone | 95/5 |
| Ln-15 | — | — | Irg 127 (3) | MEK/cyclohexanone | 95/5 |
| Ln-16 | — | — | Irg 127 (3) | MEK/cyclohexanone | 95/5 |
| Ln-17 | — | — | Irg 127 (3) | MEK/cyclohexanone | 95/5 |
| Ln-18 | — | — | Irg 127 (3) | MEK/cyclohexanone | 95/5 |
| Ln-19 | C-1 (5) | — | Irg 127 (3) | MEK/cyclohexanone | 95/5 |
| Ln-20 | D-1 (5) | — | Irg 127 (3) | MEK/cyclohexanone | 95/5 |
| Ln-21 | C-1 (5) | E-1 (40) | Irg 127 (3) | MEK/cyclohexanone | 95/5 |
| Ln-22 | C-1 (5) | E-2 (40) | Irg 127 (3) | MEK/cyclohexanone | 95/5 |

The numeral value in each of the parentheses expresses a solids content ratio (% by mass) relative to the whole of solids.

The respective compounds which were used above are as follows.

DPHA: Mixture of dipentaerythritol pentaacrylate and dipentaerythritol hexaacrylate (manufactured by Nippon Kayaku Co., Ltd.)

P-1: Fluorine-containing copolymer which is Illustrative Compound (P-1) disclosed in JP-A-2007-293325 and which is a fluorine-containing copolymer containing silicone in a main chain thereof and having a hydroxyl group and an acryloyl group as a polymerizable functional group in a side chain thereof, number average molecular weight: 30,000, Mw/Mn=1.6

Irg 127: IRGACURE 127, polymerization initiator [manufactured by Ciba Specialty Chemicals]

S-1: Photo cationic polymerization initiator (RHODOSIL 2074)

C-1: OPTOOL DAC, fluorine based UV curing antifouling additive (manufactured by Daikin Industries, Ltd.)

D-1: X22-164C, reactive silicone (manufactured by Shin-Etsu Chemical Co., Ltd.)

F-1, F-35, F-37 and F-49: Each compound described as the foregoing specific example of the polyfunctional fluorine-containing monomer (A)

HEAA: Hydroxyethyl acrylamide, manufactured by Kohjin Co., Ltd.

### [Preparation of Antireflection Film Samples CVLn-1 to CVLn-22]

A coating solution for hard coat layer (HC-1 solution) was coated on a triacetyl cellulose film “TAC-TD80U” (manufactured by Fujifilm Corporation) having a film thickness of 80 μM and a width of 1,340 mm under a condition at a conveying rate of 30 m/min by a micro gravure coating mode and dried at 60° C. for 150 seconds; and thereafter, the coating layer was cured upon irradiation with ultraviolet rays having a radiation illuminance of 400 mW/cm² and an irradiation dose of 150 mJ/cm² by using an air-cooled metal halide lamp (manufactured by Eyegraphics Co., Ltd.) of 160 W/cm under purging with nitrogen (oxygen concentration: not more than 0.1%), thereby preparing a hard coat layer.

### (Application of Low Refractive Index Layer)

On the obtained hard coat layer (HC-1), a low refractive index layer was formed using the foregoing coating solution for low refractive index layer (any one of Ln-1 to Ln-22) by a micro gravure coating mode while regulating the film thickness of the low refractive index layer to a desired film thickness, thereby preparing an antireflection film sample.

A curing condition of each of Ln-1 to Ln-10 and Ln-12 to Ln-22 is as follows.

(1) Drying: 80° C. for 120 seconds
(2) Thermal treatment before irradiation: 95° C. for 15 seconds
(3) UV curing: 90° C. for one minute

Ultraviolet rays having a radiation illuminance of 120 mW/cm² and an irradiation dose of 240 mJ/cm² were irradiated by using an air-cooled metal halide lamp (manufactured by Eyegraphics Co., Ltd.) of 240 W/cm while purging with nitrogen so as to keep a circumstance where the oxygen concentration was not more than 0.01% by volume.

(4) Thermal treatment after irradiation: 30° C. for 5 minutes

A curing condition of Ln-11 is the same as that described previously, except that the thermal treatment (4) after irradiation was changed as follows.

(4) Thermal condition after irradiation: 80° C. for 20 minutes

### (Saponification Treatment of Antireflection Film)

Each of the obtained antireflection film samples was subjected to the following saponification treatment. 1.5 moles/L of a sodium hydroxide aqueous solution was prepared and kept at 55° C. 0.005 moles/L of a dilute sulfuric acid aqueous solution was prepared and kept at 35° C. After the prepared antireflection film was dipped in the foregoing sodium hydroxide aqueous solution for 2 minutes, the resulting antireflection film was dipped in water, thereby thoroughly washing away the sodium hydroxide aqueous solution. Subsequently, after dipping in the foregoing dilute hydrochloric aqueous solution for one minute, the resulting antireflection film was dipped in water, thereby thoroughly washing away the dilute sulfuric acid aqueous solution. Finally, the sample was dried at 120° C. for 3 minutes. There was thus prepared a saponified antireflection film.

A combination of the hard coat layer and the low refractive index layer along with its film thickness is shown in the following Table 4. The refractive index of each layer was measured directly with Abbe refractometer. The refractive index of the hard coat layer prepared with the coating solution HC-1 is a value of the matrix after curing (refractive index of the film excluding light diffusible particle).

TABLE 4

| | Hard coat layer | | | Low refractive index layer | | | |
|---|---|---|---|---|---|---|---|
| Antireflection film | | | refractive | | | refractive | |
| sample No. | Coating solution | Film thickness | index | Coating solution | Film thickness | index | Remark |
| CVLn-1 | HC-1 | 13.5 μm | 1.52 | Ln-1 | 100 nm | 1.46 | Example |
| CVLn-2 | HC-1 | 13.5 μm | 1.52 | Ln-2 | 100 nm | 1.46 | Example |
| CVLn-3 | HC-1 | 13.5 μm | 1.52 | Ln-3 | 100 nm | 1.46 | Comparison |
| CVLn-4 | HC-1 | 13.5 μm | 1.52 | Ln-4 | 100 nm | 1.46 | Comparison |
| CVLn-5 | HC-1 | 13.5 μm | 1.52 | Ln-5 | 100 nm | 1.515 | Comparison |
| CVLn-6 | HC-1 | 13.5 μm | 1.52 | Ln-6 | 100 nm | 1.515 | Comparison |
| CVLn-7 | HC-1 | 13.5 μm | 1.52 | Ln-7 | 100 nm | 1.515 | Comparison |
| CVLn-8 | HC-1 | 13.5 μm | 1.52 | Ln-8 | 100 nm | 1.515 | Comparison |
| CVLn-9 | HC-1 | 13.5 μm | 1.52 | Ln-9 | 100 nm | 1.47 | Example |
| CVLn-10 | HC-1 | 13.5 μm | 1.52 | Ln-10 | 100 nm | 1.46 | Example |
| CVLn-11 | HC-1 | 13.5 μm | 1.52 | Ln-11 | 100 nm | 1.47 | Example |
| CVLn-12 | HC-1 | 13.5 μm | 1.52 | Ln-12 | 100 nm | 1.46 | Example |
| CVLn-13 | HC-1 | 13.5 μm | 1.52 | Ln-13 | 100 nm | 1.46 | Example |
| CVLn-14 | HC-1 | 13.5 μm | 1.52 | Ln-14 | 100 nm | 1.46 | Example |
| CVLn-15 | HC-1 | 13.5 μm | 1.52 | Ln-15 | Impossible | Unmeasurable | Comparison |
| | | | | | coating | | |
| CVLn-16 | HC-1 | 13.5 μm | 1.52 | Ln-16 | 100 nm | Unmeasurable | Comparison |
| CVLn-17 | HC-1 | 13.5 μm | 1.52 | Ln-17 | 100 nm | 1.46 | Example |
| CVLn-18 | HC-1 | 13.5 μm | 1.52 | Ln-18 | 100 nm | 1.46 | Example |
| CVLn-19 | HC-1 | 13.5 μm | 1.52 | Ln-19 | 100 nm | 1.47 | Example |
| CVLn-20 | HC-1 | 13.5 μm | 1.52 | Ln-20 | 100 nm | 1.47 | Example |
| CVLn-21 | HC-1 | 13.5 μm | 1.52 | Ln-21 | 100 nm | 1.44 | Example |
| CVLn-22 | HC-1 | 13.5 μm | 1.52 | Ln-22 | 100 nm | 1.41 | Example |

### [Evaluation of Antireflection Film]

Each of the obtained antireflection film samples was evaluated with respect to the following items. The evaluation results are shown in the following Table 5.

### (Evaluation 1) Average Integrated Reflectance:

After the film was stuck onto a polarizing plate of cross nicol, a spectral reflectance was measured at an incident angle of 5° in a wavelength region of from 380 to 780 nm using a spectrophotometer (manufactured by JASCO Corporation). An integrated average reflectance at from 450 to 650 nm was employed for the result. When the affinity at an interface between the low refractive index layer and an adjacent layer, microscopic unevenness is generated, resulting in an elevation of the integrated reflectance.

### (Evaluation 2) Evaluation of Antifouling Properties (Marker Ink Wiping Properties):

A film is fixed on a glass surface by an adhesive; a circle of a diameter of 5 mm is written in three times by a pen tip (fine) of a black marking pen “McKee Ultra-fine (a trade name of Zebra Co., Ltd.)” under a condition at 25° C. and 60 RH %; and after 5 seconds, wiping is carried out 20 reciprocations by a bundle of ten-ply folded BEMCOT (a trade name of Asahi Kasei Corporation) under a load to an extent that the BEMCOT bundle is indented. By repeating the foregoing writing and wiping under the foregoing condition until the marker ink mark does not disappear by wiping, it is possible to evaluate antifouling properties in terms of the number of wiping at which wiping is possible. The number of wiping at which wiping is possible was evaluated with its upper limit being 50 times. The number of wiping until the marker ink mark does not disappear is preferably 5 or more, more preferably 10 or more, and most preferably 50 or more.

### (Evaluation 3) Evaluation of Scar Resistance:

By using a rubbing tester, a rubbing test was carried out under the following condition.

Evaluation circumstance condition: 25° C., 60% RH

Rubbing material: A steel wool (manufactured by Nippon Steel Wool Co., Ltd., No. 0000) was wound around a tip part (1 cm×1 cm) of the tester coming into contact with a sample and fixed by a band such that the sample did not move. Then, a reciprocal rubbing movement was given under the following condition.

Movement distance (one way): 13 cm

Rubbing rate: 13 cm/sec

Load: 500 g/cm²

Contact area of tip part: 1 cm×1 cm

Number of rubbing: 10 reciprocations

An oily black ink was applied in the rear side of the rubbed sample, and a scar of the rubbed portion was evaluated by visual observation by reflected light according to the following criteria.

A: Even by very careful observation, a scar is not observed at all.

AB: By every careful observation, a weak scar is slightly observed.

B: A weak scar is observed.

BC: A scar is observed to a medium extent.

C: A scar is observed at the first glance.

### (Evaluation 4) Evaluation of Adhesion:

The antireflection film sample was subjected to humidity control under a condition at a temperature of 25° C. and a relative humidity of 60%. In each of the samples, the surface in a side at which the low refractive index layer was present was subjected to cross-cutting with 11 lines in length and 11 lines in width by using a cutter knife, thereby providing 100 squares in total; a polyester pressure sensitive adhesive tape (No. 31B) manufactured by Nitto Denko Corporation was stuck thereonto; after elapsing 30 minutes, the tape was quickly peeled away in a vertical direction; the number of peeled squares was counted; and the evaluation was carried out according to the following criteria of four grades. The same adhesion evaluation was repeated thrice, and an average value thereof was taken.

A: Peeling was not observed at all in the 100 squares.

B: Peeling was observed in one or two squares of the 100 squares.

C: Peeling was observed in three to ten squares of the 100 squares (within a tolerable range).

D: Peeling was observed in eleven or more squares of the 100 squares.

### (Evaluation 5) Surface Resistance:

A surface resistance of the surface of the antireflection film in the side having a low refractive index layer (outermost layer) was measured under a condition at 25° C. and a relative humidity of 60% by using a megger/micro ammeter “TR8601” (manufactured by Advantest Corporation). The results are shown in a terms of a common logarithm log (SR) of the surface resistance.

### (Evaluation 6) Dustproof Properties:

A side of the support of each of the antireflection film samples was stuck on the surface of CRT, and the resulting sample was used in a room having 1,000,000 to 2,000,000 dusts and tissue paper wastes of 0.5 μm or more per 1 ft³ (cubic foot) for 24 hours. The number of attached dusts and tissue paper wastes per 100 cm² of the antireflection film was measured. As a result, the case where the average value is less than 20 was evaluated as “A”; the case where the average value is from 20 to 29 was evaluated as “B”; the case where the average value is from 50 to 199 was evaluated as “C”; and the case where the average value is 200 or more was evaluated as “D”, respectively.

### (Evaluation 7) Evaluation of Surface Properties (Evaluation of Visual Inspection of Optical Surface Properties):

The film was subjected to (1) an inspection of transmitted surface properties under a three band fluorescent lamp and (2) an inspection of reflected surface properties under a three band fluorescent lamp by applying an oily black ink on the opposite side to the layer-coated surface, thereby evaluating uniformity in surface properties (free from wind unevenness, drying unevenness, coating streak unevenness, etc.) in detail.

1: Inferiority in surface properties

2: Non-achievement of objective

3: Still requirement of an improvement

4: Considerably good

5: Extremely good

### (Evaluation 8) Maldistribution of Conductive Polymer Composition:

After the antireflection film was obliquely cut at an angle of 0.05° by a microtome, a cut section of the obtained coating film was analyzed by the TOF-SIMS method, thereby measuring distribution of the conductive polymer compound in a film thickness direction.

Thereafter, a bottom segregation ratio was calculated according to the following expression.

(Bottom segregation ratio)=[Amount of the component (A) present in a film thickness region of 50% from the center of the layer formed by applying the coating composition containing the components (A) and (B)]÷[Total amount of the component (A) present in the whole of the layer formed by applying the coating composition containing the components (A) and (B)]×100(%)

This bottom segregation ratio was evaluated on the following four grades.

A: The bottom segregation ratio is 70% or more.

B: The bottom segregation ratio is 60% or more and less than 70%.

C: The bottom segregation ratio is 55% or more and less than 60%.

D: The bottom segregation ratio is less than 55%.

The measurement by the TOF-SIMS method was carried out under the following condition.

Apparatus: TRIFTII, manufactured by Physical Electronics (PHI)

Primary ion: Ga⁺ (15 kV)

Aperture: No. 3 (Ga⁺ current amount: corresponding to 600pA)

Mapping points: 256×256 points

Mass of secondary ion to be detected: 0 to 1,000 amu [amu: atom mass unit]

Accumulated time: 60 minutes

TABLE 5

| | Integrated | | | | Surface | | | | |
|---|---|---|---|---|---|---|---|---|---|
| | reflectance | Antifouling | Scar | | resistance | Dustproof | Surface | Maldistribution | |
| Sample | (%) | properties | resistance | Adhesion | log (SR) | properties | properties | properties | Remark |
| CVLn-1 | 3.0 | 4 | AB | B | 10.3 | B | 4 | — | Example |
| CVLn-2 | 3.0 | 5 | AB | B | 9.8 | B | 4 | — | Example |
| CVLn-3 | 3.0 | 4 | AB | B | 13.1 | B | 3 | — | Comparison |
| CVLn-4 | 3.0 | 5 | AB | B | 14 | D | 4 | — | Comparison |
| CVLn-5 | 4.5 | 0 | A | A | 14 | D | 5 | — | Comparison |
| CVLn-6 | 4.5 | 0 | AB | B | 12.2 | C | 4 | D | Comparison |
| CVLn-7 | 4.5 | 0 | AB | C | 11.5 | C | 3 | — | Comparison |
| CVLn-8 | 4.5 | 0 | B | C | 10.1 | B | 3 | D | Comparison |
| CVLn-9 | 3.2 | 5 | AB | B | 9.5 | A | 4 | — | Example |
| CVLn-10 | 2.9 | 6 | A | A | 8.6 | A | 5 | B | Example |
| CVLn-11 | 3.4 | 5 | A | B | 9.9 | B | 5 | — | Example |
| CVLn-12 | 3.0 | 5 | AB | A | 8.9 | A | 5 | — | Example |
| CVLn-13 | 2.9 | 6 | AB | B | 9.5 | A | 5 | — | Example |
| CVLn-14 | 3.1 | 5 | AB | B | 9.4 | A | 5 | — | Example |
| CVLn-15 | — | — | — | — | — | — | — | — | Comparison |
| CVLn-16 | Bad | — | BC | — | 14.0 | D | 1 | — | Comparison |
| CVLn-17 | 3.1 | 10 | A | B | 8.2 | A | 4 | — | Example |
| CVLn-18 | 3.1 | 10 | A | A | 8.0 | A | 5 | — | Example |
| CVLn-19 | 3.2 | 25 | A | A | 7.8 | A | 5 | A | Example |
| CVLn-20 | 3.2 | 20 | A | A | 7.6 | A | 5 | A | Example |
| CVLn-21 | 2.5 | 25 | A | A | 7.2 | A | 5 | — | Example |
| CVLn-22 | 1.9 | 25 | A | A | 7.1 | A | 5 | — | Example |

It is understood that CVLn-1, CVLn-2, CVLn-9 to CVLn-14 and CVLn-17 to CVLn-22, all of which are concerned with the Examples of the invention, are low in reflectance and surface resistance and have favorable performances in antifouling properties, scar resistance and adhesion.

It was noted that in CVLn-16 using non-hydrophobilized (B-2) having a relative dielectric constant of the solvent exceeding 30, which is concerned with the Comparative Example, when formed into a coating film, the surface properties is poor (For this reason, the refractive index of the low refractive index layer could not be measured.), and the conductive polymer composition are coagulated. Also, because of the deteriorated coating surface properties, the antifouling properties and adhesion could not be evaluated.

Also, in CVLn-3 whose conductive polymer composition is (B-7) in which a monoanion (not corresponding to the polymer dopant) is doped in the polythiophene derivative by electrolytic polymerization, the surface resistance value log(SR) was high so that the conductivity could not be substantially imparted as an antireflection film. The surface resistance value log(SR) of this sample before the saponification treatment was measured and found to be 11.2. It may be assumed that this was caused due to the fact that a part of the monoanion elutes outside the film due to the saponification treatment, whereby the conductivity is greatly reduced. On the other hand, the samples containing a conductive polymer using the polyanion dopant of the invention were substantially free from a change in the surface resistance value before and after the saponification and had a saponification aptitude.

In preparing a cured film using the conductive polymer composition as the component (B) together with a non-fluorine-containing polyfunctional acrylate monomer, for the purpose of enhancing the scar resistance or adhesion, when the amount of the monomer is increased and the proportion of the conductive polymer composition is decreased, the surface resistance value greatly increases (the order of the samples CVLn-8→CVLn-7→CVLn-6). On the other hand, in the case where the conductive polymer composition as the component (B) is used together with the polyfunctional fluorine-containing monomer as the component (A) of the invention, there gives rise to a special effect that even when the proportion of the conductive polymer composition is decreased, the elevation of the surface resistance value is small, and an antireflection film with low reflection and having excellent antifouling properties, scar resistance and adhesion is obtainable (compare the samples CVLn-9 and CVLn-2).

As a result of evaluating the maldistribution properties of the organic conductive polymer in a film thickness direction in the low refractive index layer of the antireflection films of CVLn-6, CVLn-8, CVLn-10, CVLn-19 and CVLn-20, in CVLn-10, CVLn-19 and CVLn-20 according to the invention, the conductive polymer composition was strongly maldistributed in a bottom (support side) in the low refractive index layer, and the contact frequency between the conductive polymer molecules increased. Thus, it was revealed that a low surface resistance value was realized.

Also, it was noted that the antireflection film of the invention exhibits a stable surface resistance value not relying upon a relative humidity in the range of from 20% to 85% and is low in the circumferential reliance.

### [Evaluation of Clear HC]

Next, antireflection films CLLn-1 to CLLn-22 were prepared by changing the coating solution of the hard coat layer of CVLn-1 to CVLn-22 shown in Table 4 from HC-1 to HC-2 shown in Table 2 and regulating the film thickness to 6 μM. The refractive index of the hard coat layer prepared with the coating solution HC-2 was measured directly with Abbe refractometer and was 1.52. The obtained antireflection films were evaluated in the same manners. As a result, the antireflection film samples CLLn-1, CLLn-2, CLLn-9 to CLLn-14 and CLLn-17 to CLLn-22, all of which are concerned with the Examples of the invention, had low reflectance and surface resistance and had favorable performances in antifouling properties, scar resistance and adhesion as compared the comparative samples.

### [Evaluation in Liquid Crystal Display Device]

### (Preparation of Polarizing Plate)

The both surfaces of a polarizer which had been prepared by adsorbing iodine onto polyvinyl alcohol and stretched were adhered to and protected by an 80 μm-thick triacetyl cellulose film (TAC-TD80U, manufactured by Fujifilm Corporation) which had been dipped in an NaOH aqueous solution of 1.5 moles/L at 55° C. for 2 minutes, neutralized and then washed with water and each of the films of the respective samples (saponified) in the antireflection films CVLn-1 to CVLn-22, thereby preparing a polarizing plate.

### (Preparation of Liquid Crystal Display Device)

A polarizing plate and a retardation film provided in a VA mode liquid crystal display device (LC-37GS10, manufactured by Sharp Corporation) were peeled off, and instead, each of the above-prepared polarizing plates was stuck such that its transmission axis was coincident with that of the polarizing plate stuck onto the product, thereby preparing a liquid crystal display device having each of the antireflection films CVLn-1 to CVLn-22. The polarizing plate was stuck such that optical laminate faced the viewing side.

With respect to the thus prepared polarizing plate and image display device, similar to the respective stuck antireflection films, the Examples exhibited excellent surface properties, scratch resistance, antifouling properties and adhesion without causing whitening, streaks and unevenness as compared with the Comparative Examples. Also, in the Examples, a liquid crystal display device which is extremely small in reflection of the background, very high in display grade and excellent in antifouling properties was obtained.

1. An antireflection film comprising a support and a low refractive index layer formed from a composition for low refractive index layer containing the following (A) and (B), wherein a common logarithm log(SR) of a surface resistivity SR (Ω/sq) of a surface of the antireflection film on a side at which the low refractive index layer is provided is not more than 13.0:
(A) a polyfunctional fluorine-containing monomer having a polymerizable group; and
(B) a hydrophobilized conductive polymer composition containing a π-conjugated system conductive polymer and an anion group-containing polymer dopant.

2. The antireflection film according to claim 1, wherein the polymerizable group is a polymerizable unsaturated group.

3. The antireflection film according to claim 1, wherein the polymerizable group is a group selected from an acryloyl group, a methacryloyl group and —C(O)OCH═CH₂.

4. The antireflection film according to claim 1, wherein the π-conjugated system conductive polymer is one of polythiophene, polyaniline, a polythiophene derivative and a polyaniline derivative.

5. The antireflection film according to claim 1, wherein the composition for low refractive index layer further contains at least one of a fluorine-containing antifouling agent and a silicone based antifouling agent.

6. The antireflection film according to claim 1, wherein the composition for low refractive index layer further contains an inorganic particle having a particle size of from 5 nm to 120 nm.

7. The antireflection film according to claim 6, wherein the inorganic particle has a pore in an inside thereof.

8. The antireflection film according to claim 7, wherein the inorganic particle is a hollow silica particle whose porosity is from 10 to 80%.

9. The antireflection film according to claim 1, wherein the common logarithm log(SR) of a surface resistivity SR (Ω/sq) of a surface of the antireflection film on a side at which the low refractive index layer is provided is not more than 11.0.

10. The antireflection film according to claim 1, wherein the common logarithm log(SR) of a surface resistivity SR (Ω/sq) of a surface of the antireflection film on a side at which the low refractive index layer is provided is not more than 9.0.

11. The antireflection film according to claim 1, wherein the π-conjugated system conductive polymer is unevenly distributed in a thickness direction of the low refractive index layer.

12. A polarizing plate comprising a polarizing film and a protective film, wherein the protective film is an antireflection comprising a support and a low refractive index layer formed from a composition for low refractive index layer containing the following (A) and (B), wherein a common logarithm log (SR) of a surface resistivity SR (Ω/sq) of a surface of the antireflection film on a side at which the low refractive index layer is provided is not more than 13.0;
(A) a polyfunctional fluorine-containing monomer having a polymerizable group; and
(B) a hydrophobilized conductive polymer composition containing a π-conjugated system conductive polymer and an anion group-containing polymer dopant.

13. An image display device comprising an antireflection film comprising a support and a low refractive index layer formed from a composition for low refractive index layer containing the following (A) and (B) wherein a common logarithm log(SR) of a surface resistivity SR (Ω/sq) of a surface of the antireflection film on a side at which the low refractive index layer is provided is not more than 13.0:
(A) a polyfunctional fluorine-containing monomer having a polymerizable group; and
(B) a hydrophobilized conductive polymer composition containing a π-conjugated system conductive polymer and an anion group-containing polymer dopant.
